(19) United States
(12) Patent Application Publication
(10) Pub. No.: US 2013/0246994 A1
(43) Pub. Date: Sep. 19, 2013

(54) WIRING CHECK DEVICE AND WIRING CHECK SYSTEM

(71) Applicant: Ken Morishita, Tokyo (JP)

(72) Inventor: Ken Morishita, Tokyo (JP)

(73) Assignee: NEC CORPORATION, Tokyo (JP)

(21) Appl. No.: 13/988,882

(22) PCT Filed: Nov. 22, 2011
(86) PCT No.: PCT/JP2011/077449

§ 371 Date: May 22, 2013

(30) Foreign Application Priority Data
Dec. 1, 2010 (JP) 2010-268547

(51) Int. Cl. G06F 17/50

(52) U.S. Cl. CPC G06F 17/5081
USPC 716/136

(57) ABSTRACT

The purpose of the present invention is to provide a wiring check device, a wiring check system, a wiring check method, a wiring check program, and a recording medium, which are capable of taking into account a difference in the shape of a slit to find a risk of the worsening of electromagnetic noise characteristics. A wiring check device comprising: a wiring information acquiring unit for acquiring the wiring information of wiring; a first plane conducting body detecting unit for detecting a first plane conducting body adjacent to the wiring; a crossing wiring determining unit for detecting overlapped projections of the wiring and the first plane conducting body, and determining whether or not the wiring is a crossing wiring crossing a border line between a forming region of the first plane conducting body and a non-forming region of the first plane conducting body; and a closed curve length detecting unit for detecting closed curve length of the border line if it is determined that the wiring is a crossing wiring.

### TECHNICAL FIELD

The present invention relates to a wiring check device of a printed wiring board and a wiring check system thereof.

### BACKGROUND ART

In an LSI (Large Scale Integration) and a printed wiring board thereon mounting ICs (Integrated Circuits), it is necessary to improve electromagnetic noise characteristics. That is, it is necessary to suppress emission of unnecessary electromagnetic noise to outside, and to prevent destruction and malfunction due to the electromagnetic noise mixed from the outside.

If design change to improve an electromagnetic noise characteristic and an addition of a measure component are performed after production of a printed wiring board, it leads to prolongation in a development period and increase of the production cost. For this reason, it is desirable to check an electromagnetic noise characteristic in a design cycle of a printed wiring board, and to take measures to improve the electromagnetic noise characteristic if need.

It is known that an electromagnetic noise characteristic of a printed wiring board worsens if a plane conducting body opposed to a wiring is missed and the wiring crosses the missing part of the plane conducting body.

There are many parts where conductors are missed, such as many gaps for dividing a via, a power supply or a ground, and notches for passing through wirings in a plane conductor body used as the power supply or the ground of a printed circuit board. Henceforth, a part where the conductors are missed, such as many gaps for dividing the via, the power supply or the ground, and notches for passing the wirings will be called a slit. In a general printed wiring board, a slit formed in a plane conducting body has various shapes as shown in FIG. 1. A cut portion in FIG. 1 shows a slit.

When a wiring is opposed such slit, a part where the wiring crosses the slit arises. And if a return path of signal current becomes far, strong electromagnetic noise is emitted. Electromagnetic noise mixed from outside becomes easy to superpose on the wiring from the slit circumference in the plane conducting body and causes destruction and malfunction of an electronic apparatus.

For example, a technology to check such wiring is disclosed in patent literature 1.

A check device disclosed in patent literature 1 extracts a wiring which crosses a specified area which is influenced easily by noise to a substrate to which layout design was performed. And interference noise is checked to this wiring. This device includes an area specification means, a wiring extraction means and an interference check means. The area specification means is a means for specifying an arbitrary area to the substrate to which the layout design was performed. The wiring extraction means is a means for extracting a wiring which crosses the area specified by the area specification means and other portions. The interference check means is a means for performing a noise interference check to the wiring extracted by the wiring extraction means. According to this device, since an area is specified depending on the plane shape of the substrate, it is said that the area specification can be performed automatically even if a user does not perform the area specification separately.

However, in the device described in patent literature 1, the user may perform the area specification for extracting the wiring. Therefore, full automation on a check is not made and there is a problem that the user has to intervene in the check stage. Although it is described that the area specification can be performed automatically by this device, the automatic area specification has the large restrictions as described in the specification paragraph [0021] of patent literature 1. That is, there are restrictions such that almost all layers of a multilayer PWB must be similar plane shapes, or it is effective where a wiring exists only in a plane layer designed in the specific shape.

A technology in relation to full automation check is disclosed in patent literature 2, for example. In a return path cutoff check system of a printed wiring board described in patent literature 2, it is detected whether a wiring on the printed wiring board is formed only on a single plane layer. In this system, a wiring and plane layers are selected from a CAD (Computer Aided Design) data automatically, and the wiring and the plane layers which are located one above the other are piled up as an image. And it is detected whether the wiring is formed only on the single plane layer. In the system described in patent literature 2, there are a few problems that a user has to intervene in the check stage and there are a few problems such as the restrictions in an automatic area specification. However, it is only information whether a wiring is formed only on the single plane layer what this system detects. Therefore, in consideration of the difference in the structures of the wiring and the plane layer, the degree of the influence by the wiring formation on a plurality of plane layers cannot be detected.

A technology in relation to a solution of such problem is disclosed in patent literature 3, for example. In patent literature 3, a plane crossing wiring check system for judging whether a wiring crosses between similar plane layers or whether it crosses between different plane layers is disclosed. In this system, a wiring and a plurality of plane layers of a check target are extracted from a CAD data, their projection overlapping are detected, and an attribute of each plane layer is also judged. And, the wiring which crosses between the similar plane layers and the wiring which crosses between the different plane layers are classified, and weighting is added to each wiring. As a result, the degrees of influence by the wiring crossing between the plane layers are classified by the levels depending on the kind of plane layers. Therefore, a wiring pattern can be checked effectively.

### PRIOR ART LITERATURE

### Patent Literature

Patent literature 1: Japanese Patent Application Laid-Open No. 2006-172370
Patent literature 2: Japanese Patent Application Laid-Open No. 2000-331048
Patent literature 3: Japanese Patent Application Laid-Open No. 2009-211405

### SUMMARY OF THE INVENTION

### Problem to be Solved by the Invention

In order to improve the electromagnetic noise characteristic of the printed wiring board, it is effective and efficient to perform a measure design with priority from a wiring a high risk of worsening an electromagnetic noise characteristic.

Here, the wiring check system described in patent literature 3 does not consider at all the difference in the risks of worsening an electromagnetic noise characteristic based on the difference in the shapes of the slit.

On the other hand, the inventors of the present application have found that the difference in an electromagnetic noise characteristic occurs by the difference in the shapes of the slit. Evaluation results of a relation between a slit shape and an electromagnetic noise characteristic will be described using FIGS. 2 to 5.

Schematic diagrams of a printed wiring board 1 used for the evaluation are shown in FIGS. 2A and 2B. A top view of the printed wiring board 1 is shown in FIG. 2A, and a sectional view thereof is shown in FIG. 2B. The printed wiring board 1 is composed of a glass epoxy board as a substrate material which is a dielectric substrate and has a 4 layer structure. The standard notation of this glass epoxy board is FR-4. A wiring 2 and a pad 3 are formed in a top layer, and plane conducting bodies 6-8 are formed in other three layers. A coaxial connector 4 for voltage measurements is connected to one end of the wiring 3 and a resistor 5 of 50 Ω for termination is connected to the other end. The pad 3 is formed in 2 mm square on the corner of the printed wiring board 1 and connected by a via 9 to the plane conducting bodies 6-8 electrically. The plane conducting bodies 6-8 are connected electrically each other by the vias 9 arranged in the printed wiring board 1 at intervals of 5 mm. A slit 10 with the size of d1×d2 is formed in the plane conducting bodies 6-8 respectively in a position which is located rightly under the wiring 2. And the wiring 2 crosses a center of the slit 10. In such printed wiring board 1, an induced voltage in the wiring 2 when applying electromagnetic noise from the pad 3 on the top layer, was measured.

A similar measurement has been also performed for a case where the slit 10 formed in the plane conducting bodies 6-8 of the printed wiring board 1 is made a slit with the shape shown FIG. 3A and FIG. 3B. The slit shown in FIG. 3A is a deformed slit with the width changing. And the slit shown in FIG. 3B is a substrate end slit with the plane conducting bodies 6-8 missing to the edge. In this measurement, it is shown that when an induced voltage becomes higher, the measurement is influenced by the electromagnetic noise from the outside, that is, a risk of worsening an electromagnetic noise characteristic will become higher.

The measurement results of the induced voltage are shown in FIG. 4. In FIG. 4, a solid line represents a voltage waveform when the plane conducting bodies 6-8 have no slits as a standard, and a dashed line represents a voltage waveform when the slit size (d1×d2) is set to 2 mm×5 mm. It is found from FIG. 4 that the induced voltage becomes large in the wiring crossing the slit by applying the electromagnetic noise and thereby the electromagnetic noise characteristic of an electronic apparatus is deteriorated.

A similar measurement is performed in a case where a wiring crosses slits with the other shapes, and a Peak-to-Peak value (Vpp) which represents a maximum amplitude of the voltage in the evaluation of the induced voltage is extracted. The shape of the slit and the Peak-to-Peak value of the induced voltage are shown in FIG. 5. In order to investigate the difference in the induced voltages by the difference in the shapes of the slit, the area of the slit is also shown in the same drawing. It is found from FIG. 5 that the induced voltage also becomes higher as the area of the slit is larger. It is found that the induced voltage is different among the rectangular slit of 2 mm×5 mm, the deformed slit and the substrate end slit, each of which has a slit with the same area of 10 mm². The result was obtained the result that a large induced voltage is generated in the substrate end slit, in particular.

As mentioned above, it is effective and efficient to perform taking a measure design preferentially from a wiring with a high risk of worsening an electromagnetic noise characteristic in order to improve an electromagnetic noise characteristic of a printed wiring board. Therefore, in a system for checking a wiring, it is desirable to detect degree of a risk of worsening an electromagnetic noise characteristic considering a shape of a slit which a wiring crosses.

On the other hand, as mentioned above, in the check system described in patent literature 3, the difference in the slit shapes is not considered at all. Therefore, the electromagnetic noise characteristic cannot be improved efficiently.

Here, the degree of the risk of the deterioration of the electromagnetic noise characteristic cannot be detected correctly only by the area of the slit as found from the measurement results in FIG. 5.

Using a slit of a rectangle which is specifically simple for handling, a method to classify the level of the risk from a length and a width of a slit, and information whether as it is located at an inner side or a substrate end of a plane conducting body that the slit exists is also considered. However, there are slits with the various shapes shown in FIG. 1 and a lot of slits with the more complicated shapes in a general printed wiring board. Therefore, it is impossible to classify the level matched with the real condition of a printed wiring board cannot be done even if this method is used.

The purpose of the present invention is to provide a wiring check device, a wiring check system, a wiring check method, a wiring check program, and a recording medium, which are capable of taking into account a difference in the shape of a slit to find a risk of the worsening of electromagnetic noise characteristics.

### Means for Solving the Problem

A wiring check device in this exemplary embodiment is provided with a wiring information acquiring unit for acquiring the wiring information of wiring; a first plane conducting body detecting unit for detecting a first plane conducting body adjacent to the wiring; a crossing wiring determining unit for detecting overlapped projections of the wiring and the first plane conducting body, and determining whether or not the wiring is a crossing wiring crossing a border line between a forming region of the first plane conducting body and a non-forming region of the first plane conducting body; and a closed curve length detecting unit for detecting the closed curve length of the border line if it is determined that the wiring is a crossing wiring.

A wiring check system in this exemplary embodiment is provided with a wiring information acquiring means for acquiring the wiring information of wiring; a first plane conducting body detecting means for detecting a first plane conducting body adjacent to the wiring; a crossing wiring determining means for detecting overlapped projections of the wiring and the first plane conducting body, and determining whether or not the wiring is a crossing wiring crossing a border line between a forming region of the first plane conducting body and a non-forming region of the first plane conducting body; and a closed curve length detecting means for detecting the closed curve length of the border line if it is determined that the wiring is a crossing wiring.

A wiring check method in this exemplary embodiment includes the steps of: a wiring information acquiring step for acquiring the wiring information of wiring; a first plane conducting body detecting step for detecting a first plane conducting body adjacent to the wiring; a crossing wiring determining step for detecting overlapped projections of the wiring and the first plane conducting body, and determining whether or not the wiring is a crossing wiring crossing a border line between a forming region of the first plane conducting body and a non-forming region of the first plane conducting body by; and a closed curve length detecting step for detecting the closed curve length of the border line if it is determined that the wiring is a crossing wiring.

A wiring check program in this exemplary embodiment makes a computer execute the wiring checking method of the present invention.

A recording medium in this exemplary embodiment is an information storage medium which a computer can read, and the wiring check program of the present invention is recorded.

### Effect of the Invention

It becomes possible to take into account the difference in the shapes of the slit to find a risk of the worsening of electromagnetic noise characteristics according to the present invention.

### BRIEF DESCRIPTION OF THE DRAWINGS

FIG. 1 It shows an example of a plane conducting body in which slits with a plurality of shapes are formed.

FIG. 2 It shows a schematic diagram of a printed wiring board used for evaluation.

FIG. 3 It shows other examples of the shape of the slit of a printed wiring board used for evaluation.

FIG. 4 It shows measurement results of an induced voltage.

FIG. 5 It shows the size and the shape of the slits, and peak-to-peak values of the induced voltage.

FIG. 6 It shows an example of a structure of a wiring check system in a first exemplary embodiment of the present invention.

FIG. 7 It shows an example of the wiring checking method by the wiring check system in the first exemplary embodiment of the present invention.

FIG. 8 It shows a target printed wiring board on a wiring check by the wiring check system in the first exemplary embodiment of the present invention.

FIG. 9 It shows an example of a configuration of a wiring check system in a second exemplary embodiment of the present invention.

FIG. 10 It shows an example of a wiring checking method by the wiring check system in the second exemplary embodiment of the present invention.

FIG. 11 It shows a configuration of a target printed wiring board on a wiring check by the wiring check system in the second exemplary embodiment of the present invention.

FIG. 12 It shows results obtained in the wiring check by the wiring check system in the second exemplary embodiment of the present invention.

FIG. 13 It shows an induced voltage to a wiring by electromagnetic noise mixed from the outside of the printed wiring board.

FIG. 14 It shows a noise current which flows through the periphery of the slit and a magnetic field which occurs by the noise current.

FIG. 15 It shows a sectional view of the slit periphery of the printed wiring board.

FIG. 16 It shows the shape of the slit and the slit pattern, and a peak-to-peak value of the induced voltage.

FIG. 17 It shows a schematic diagram of a structure of the printed wiring board 11 used for evaluation.

FIG. 18 It shows sectional views of the slit periphery of three patterns of the printed wiring board.

FIG. 19 It shows the shape of the slit and the slit pattern, and a peak-to-peak value of the induced voltage.

FIG. 20 It shows an example of a configuration of a wiring check system in a third exemplary embodiment of the present invention.

FIG. 21 It shows an example of a wiring checking method by the wiring check system in the third exemplary embodiment of the present invention.

FIG. 22 It shows a method of adding for a weighting coefficient.

FIG. 23 It shows a structure of a target printed wiring board on the wiring check by the wiring check system in the third exemplary embodiment of the present invention.

FIG. 24 It shows results obtained in the wiring check by the wiring check system in the third exemplary embodiment of the present invention.

FIG. 25 It shows another example of a configuration of the wiring check system in the third exemplary embodiment of the present invention.

FIG. 26 It shows a structure of a target printed wiring board on the wiring check by the wiring check system in the third exemplary embodiment of the present invention.

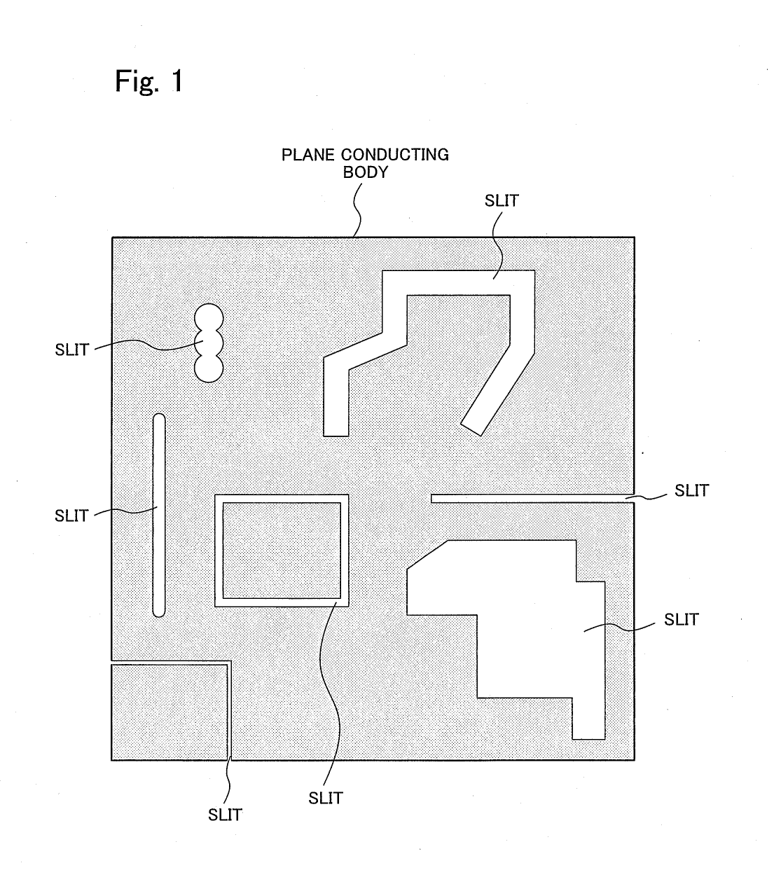

### DESCRIPTION OF EMBODIMENTS

Exemplary embodiments of the present invention will be described with reference to drawings. However, the embodiment is not limited to the technical scope of the present invention.

### First Exemplary Embodiment

A wiring check system in a first exemplary embodiment of the present invention will be described using FIG. 6.

A wiring check system 100 in this exemplary embodiment includes a wiring information acquiring means 101, a first plane conducting body detecting means 102, a crossing wiring determining means 103 and a closed curve length detecting means 104.

The wiring information acquiring means 101 acquires wiring information on a wiring. The first plane conducting body detecting means 102 detects the first plane conducting body adjacent to the wiring. The crossing wiring determining means 103 detects overlapped projections of the wiring and the first plane conducting body detected by the first plane conducting body detecting means 102. And it determines whether the wiring crosses a border line between a forming region of the first plane conducting body and a non-forming region of the first plane conducting body. Hereinafter, such a wiring which crosses the border line between the forming region of the first plane conducting body and the non-forming region of the first plane conducting body is called a crossing wiring. Here, if it was determined that the wiring is a crossing wiring, the closed curve length detecting means 104 detects a closed curve length of the border line.

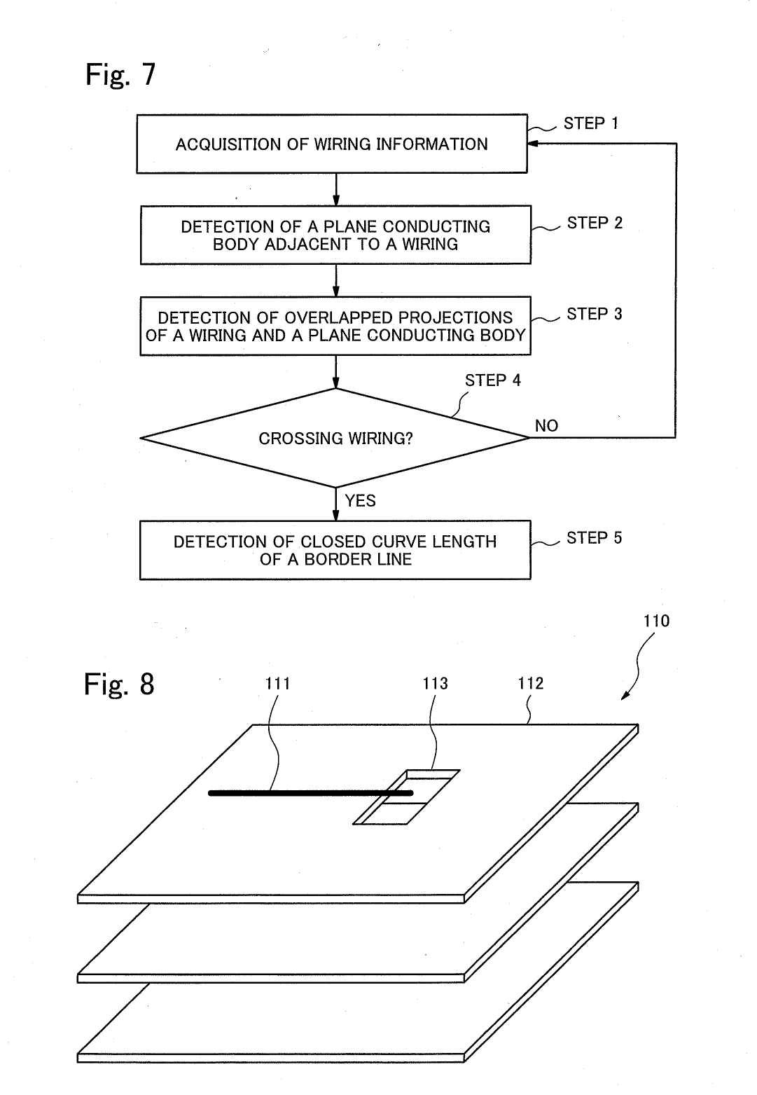

Next, a wiring checking method of a printed wiring board by the wiring check system 100 in this exemplary embodiment will be described using FIG. 7. As a printed wiring board to which a wiring check is performed by the wiring check system 100, a printed wiring board 110 shown in FIG. 8 will be used.

First, the wiring information acquiring means 101 acquires wiring information on a wiring 111 (Step 1). The wiring 111 here is a target wiring to be checked by the wiring check system 100.

Next, the first plane conducting body detecting means 102 detects the first plane conducting body adjacent to the wiring 111 (Step 2). In this exemplary embodiment, the first plane conducting body 112, which is a plane conducting body located directly below and adjacent to the wiring 111, is detected.

Next, the crossing wiring determining means 103 detects overlapped projections of the wiring 111 and the first plane conducting body 112 (Step 3). Moreover, the crossing wiring determining means 103 determines whether the wiring 111 is a crossing wiring which crosses a border line 113 between a forming region of the first plane conducting body 112 and a non-forming region of the first plane conducting body 112 (Step 4). And if it is determined that the wiring 111 is a crossing wiring, the closed curve length detecting means 104 detects a closed curve length of the border line 113 (Step 5). Here, the case where the wiring 111 is determined to be a crossing wiring means the case determined to select YES in Step 4. The closed curve length of the border line 113 in this exemplary embodiment becomes the boundary length of the slit formed in the first plane conducting body.

On the other hand, if the wiring 111 is determined not to be a crossing wiring, the process returns to Step 1 to and wiring information on other wirings is acquired. Here, the case where the wiring 111 is determined not to be a crossing wiring means the case determined to select NO in Step 4. If there are no other wirings, the wiring check by the wiring check system 100 ends.

As described above, in the wiring check system 100 in this exemplary embodiment, it is possible to detect the wiring which crosses the border line between the forming region and the non-forming region of the plane conducting body, and the closed curve length of the border line. As a result, a difference in the shapes of the slit can be taken into account to find a risk of the worsening of electromagnetic noise characteristics. Therefore, it becomes possible to improve the electromagnetic noise characteristics of the printed wiring board can be improved more efficiently.

The wiring check system 100 in this exemplary embodiment may include a single device or may include a plurality of devices.

### Second Exemplary Embodiment

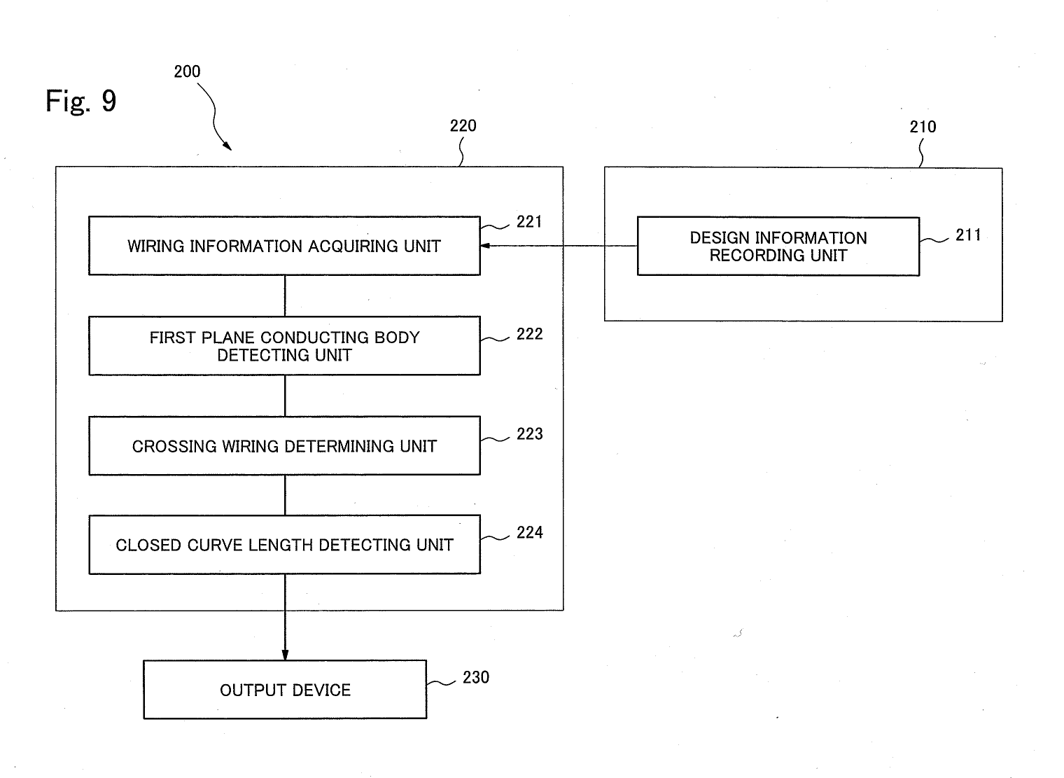

A wiring check system in a second exemplary embodiment of the present invention will be described using FIG. 9. A wiring check system 200 in this exemplary embodiment includes a recording device 210, a wiring check device 220 and an output device 230. The wiring check device 220 is in the state that it can communicate with the recording device 210 and the output device 230 respectively by wire or wireless.

The recording device 210 includes a design information recording unit 211. The design information recording unit 211 records design information on a printed wiring board, for example a CAD data. For example, location information on a wiring of the printed wiring board is included in the design information.

The wiring check device 220 includes a wiring information acquiring unit 221, a first plane conducting body detecting unit 222, a crossing wiring determining unit 223 and a closed curve length detecting unit 224.

The wiring information acquiring unit 221 refers to the design information recorded in the design information recording unit 211 and acquires wiring information on the wiring to be a check target. The first plane conducting body detecting unit 222 detects a first plane conducting body adjacent to the wiring. The crossing wiring determining unit 223 detects overlapped projections of the wiring and the first plane conducting body detected by the first plane conducting body detecting unit 222. And it determines whether the wiring is a crossing wiring which crosses a border line between a forming region and a non-forming region of the first plane conducting body. Here, if it is determined that the wiring of the check target is a crossing wiring, the closed curve length detecting unit 224 detects the closed curve length of the border line.

The output device 230 outputs the information on the closed curve length detected by the closed curve length detecting unit 224.

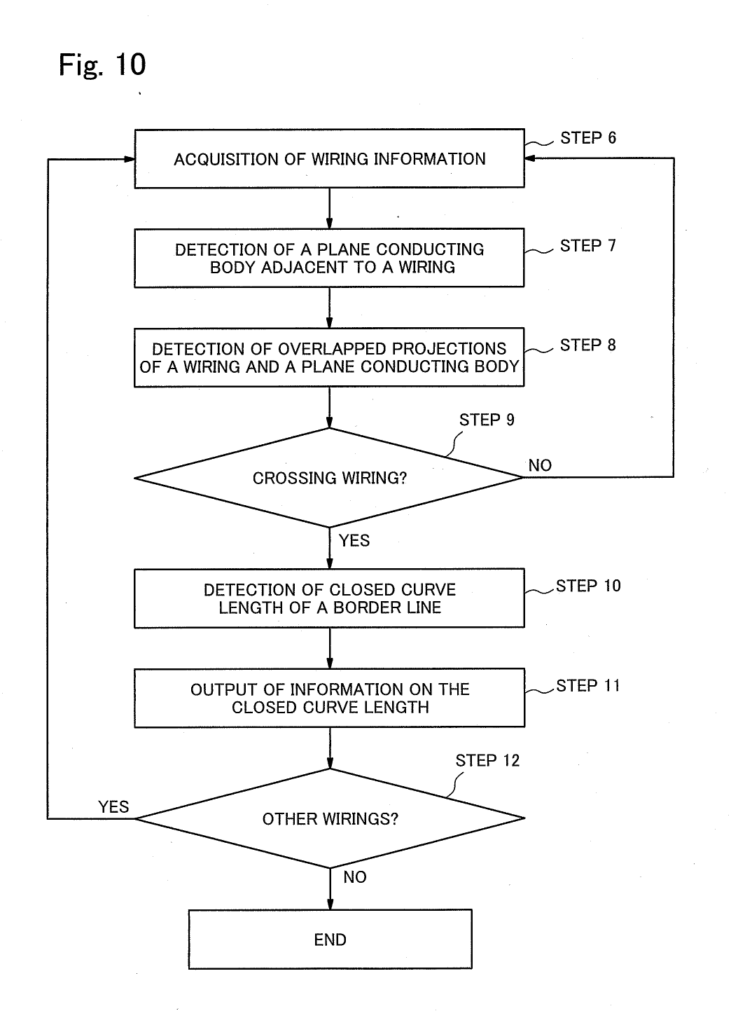

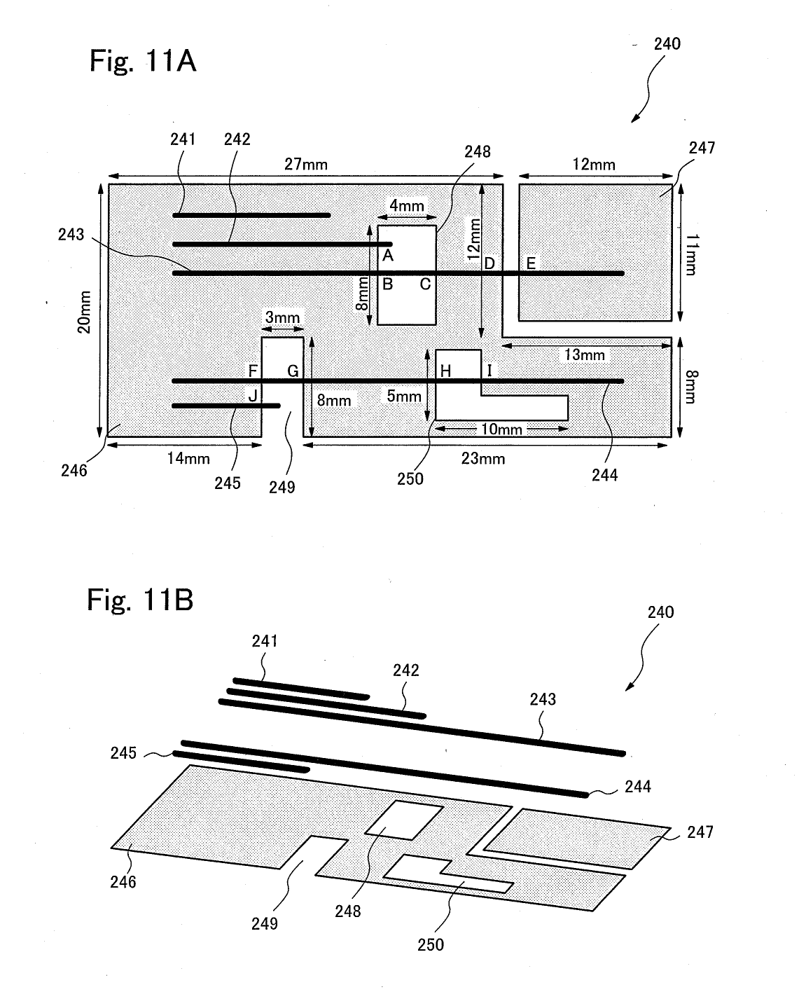

Next, a wiring checking method of a printed wiring board by the wiring check system 200 in this exemplary embodiment will be described using a flowchart shown in FIG. 10. As a printed wiring board to which a wiring check is performed by the wiring check system 200, a printed wiring board 240 shown in FIG. 11 will be used. FIG. 11 is a schematic diagram which has extracted only one layer plane conducting body and wirings formed above it from the structure of the printed wiring board 240. FIG. 11A shows a top view and FIG. 11B shows a perspective view. Two plane conducting bodies 246 and 247 and five wirings 241-245 are included in a structure shown in FIG. 11, and in ten positions represented by points A to J, any wiring is crossing a border line between a forming region and a non-forming region of the plane conducting body. It is supposed that the design information on the printed wiring board to which a wiring check is performed is recorded in advance in the design information recording unit 211.

First, the wiring information acquiring unit 221 reads the design information on the printed wiring board 240 recorded in the design information recording unit 211, and acquires the wiring information on the wiring to be a check target therefrom (Step 6). For example, the wiring information includes information on position coordinates of a wiring, and a wiring layer. Here, the position coordinate of the wiring is a XY coordinates or the like. In the case of this exemplary embodiment, wiring information on the wiring 241 will be acquired at the beginning among wirings 241-245 formed in the printed wiring board 240.

Next, the first plane conducting body detecting unit 222 reads the design information on the printed wiring board 240 again, and detects a plane conducting body adjacent to the wiring 241 in a substrate multilayered direction (Step 7). In case of this exemplary embodiment, the plane conducting body 246 adjacent to the wiring 241 is detected.

Next, the crossing wiring determining unit 223 detects overlapped projections of the wiring 241 and the plane conducting body 246 (Step 8). The detection of that overlapped projections is also performed by reading the design information on the printed wiring board 240. And the crossing wiring determining unit 223 determines whether the wiring 241 is a crossing wiring which crosses a border line between a forming region and a non-forming region of the plane conducting body 246 (Step 9). Here, as shown in FIG. 11, the wiring 241 is arranged only on the forming region of the plane conducting body 246. Therefore, it is determined that the wiring 241 is not a crossing wiring. Here, a case determined that it is not a crossing wiring means the case determined to select NO in Step 9.

If the wiring 241 which has become a check target is determined not to be a crossing wiring, the process returns to Step 6 again, and the wiring information acquiring unit 221 acquires wiring information on other wirings. Here, wiring information on the wiring 242 will be acquired.

And by Step 7, as a plane conducting body adjacent to the wiring 242, the plane conducting body 245 is detected. And by Step 8, overlapped projection of the wiring 242 and the plane conducting body 246 is detected, and it is determined by Step 9 whether the wiring 242 is a crossing wiring. Here, the wiring 242 is crossing the periphery of the slit 248 of border line between a forming region and a non-forming region of the plane conducting body 246 at the point A. Therefore, the crossing wiring determining unit 223 determines that the wiring 242 is a crossing wiring. Here, the case that the wiring 242 determined to be a crossing wiring means the case determined to select YES in Step 9.

In this case, the closed curve length detecting unit 224 detects the closed curve length of the border line including the point A (Step 10). In this exemplary embodiment, the closed curve length of the border line represents the boundary length of the slit 248. Therefore, in Step 10, a value of 24 mm which is the boundary length of the slit 248 (4 mm×8 mm) is detected. The detection of the closed curve length of the border line is performed by reading the design information recorded in the design information recording unit 211.

And the information on the closed curve length detected by the closed curve length detecting unit 224 is transmitted to the output device 230. The output device 230 outputs the received information on the closed curve length (Step 11). Here, the output device 230 may display the received information on the closed curve length on a display screen or may print it.

If there is a target wiring for wiring check in addition to the wiring 242, that is, in the case determined to select YES in Step 12, the wiring information acquiring unit 221 reads the design information again and acquires wiring information on the other wirings (Step 6). Here, the wiring information on a wiring 243 will be acquired.

And by Step 7, as a plane conducting body adjacent to the wiring 242, plane conducting bodies 246 and 247 are detected. And by Step 8, overlapped projections of the wiring 243 and each of plane conducting bodies 246 and 247 are detected. It is determined by Step 9 whether the wiring 243 is a crossing wiring.

Here, the wiring 243 is crossing a respective border line between the forming regions and non-forming regions of the plane conducting body 246 and the plane conducting body 247 at the points of B, C, D and E. Therefore, the crossing wiring determining unit 223 determines that the wiring 243 is a crossing wiring. Here, the case where the crossing wiring determining unit 223 determines that the wiring 243 is a crossing wiring means tha case determined to select YES in Step 9. And the closed curve length detecting unit 224 detects the closed curve length of the border line including the points of B, C, D and E (Step 10). Here, the closed curve length of the border line including the points B and C represents the boundary length of the slit 248, and its value becomes equal to 24 mm as described above. On the other hand, the closed curve length of the border line at the point D represents a peripheral length of the plane conducting body 246 and its value becomes equal to 136 mm. The closed curve length of the border line at the point E represents a peripheral length of the plane conducting body 247, and its value is equal to 46 mm.

And the information on the closed curve length is transmitted to the output device 230 (Step 11). And then Steps 6-11 are repeated for each wiring until a wiring to be a check target is cleared.

The wiring 244 is crossing a border line between a forming region and a non-forming region of the plane conducting body 246 at the points of F, G, H and I. Therefore, in Step 10, the closed curve length of the border line including the points F and G, and the closed curve length of the border line including the points H and I are detected. A slit 249 is a substrate end slit in which a plane conducting body is missed to the substrate end of the plane conducting body 246. Therefore, the closed curve length of the border line including the points F and G represents a peripheral length of the plane conducting body 246 including the boundary length of the slit 249, and its value becomes equal to 136 mm. The closed curve length of the border line including the points H and I represents the boundary length of the slit 250, and its value becomes equal to 30 mm. The slit 250 is a deformed slit with the shape formed by combining two rectangles.

And, the wiring 245 is crossing a border line between a forming region and a non-forming region of the plane conducting body 246 at the point J. Therefore, in Step 10, the closed curve length of the border line including the point J is detected. Here, the closed curve length of the border line including the point J represents a peripheral length of the plane conducting body 246, and its value becomes equal to 136 mm.

Thus, when the wiring check of all wirings 241-245 has completed, that is, when determined to select NO in Step 12, the wiring check by the wiring check system 200 has been completed.

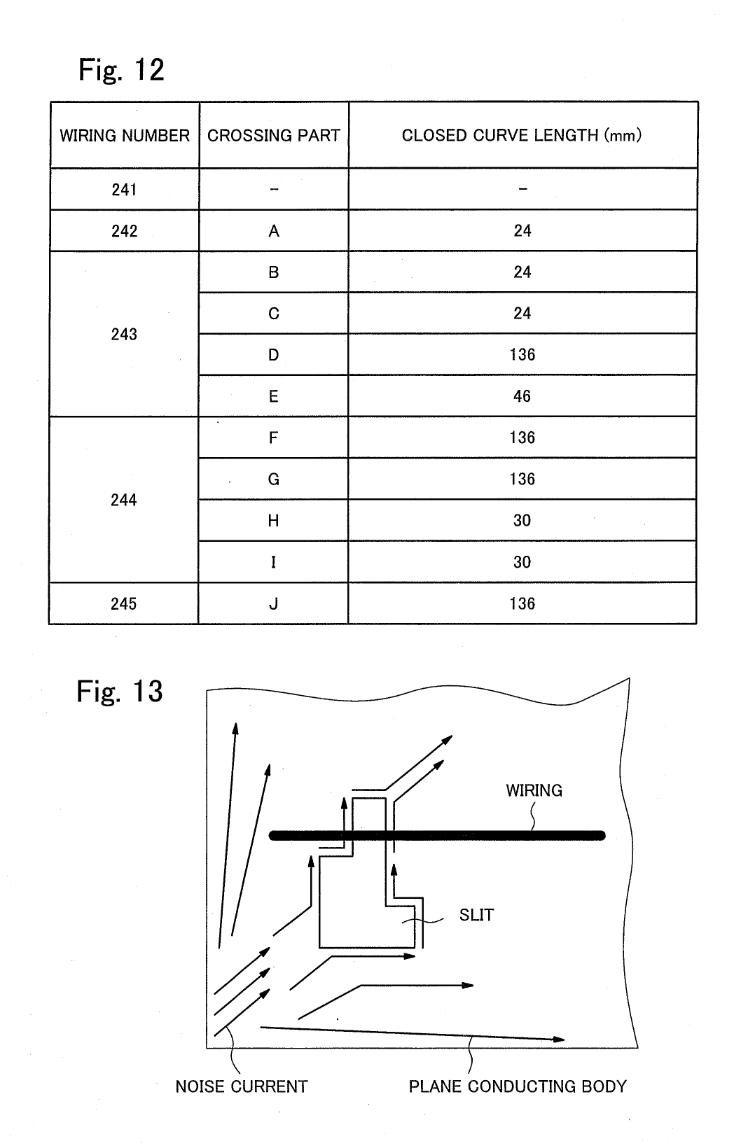

The detection results obtained by the wiring check system 200 in this exemplary embodiment are shown in FIG. 12. FIG. 12 shows the results by correlating the number of the wiring to the closed curve length of the border line including the points A to J which each wiring crosses.

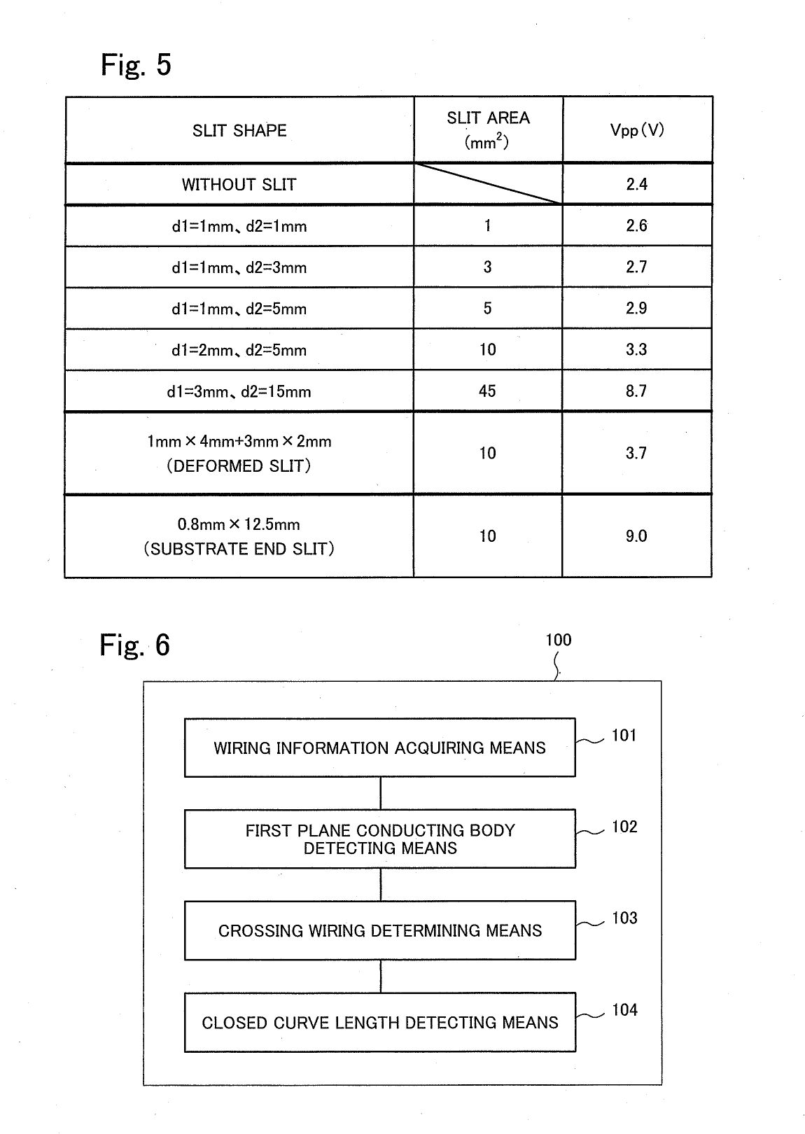

And the closed curve length shown in FIG. 12 can be used as an index by which a risk of worsening an electromagnetic noise characteristic is judged. That is, a risk of worsening an electromagnetic noise characteristic becomes higher as the closed curve length is longer. In this exemplary embodiment, the risk of worsening the electromagnetic noise characteristics becomes highest in the parts of the point D between the two plane conductor bodies 246 and 247, and the points F, G and J in the substrate end slit 249. When a wiring crosses between different plane conductor bodies like in the points D and E, it is generally known as disclosed in patent literature 3 that a risk of worsening an electromagnetic noise characteristic becomes higher. And when a wiring crosses a substrate end slit like at the points F and G, it is obvious from the measurement results shown in FIG. 5 that a risk of worsening an electromagnetic noise characteristic becomes higher. Moreover, although the area of the slit 248 including the points A, B and C, and the area of the deformed slit 250 including the points H and I are same in 32 mm², the boundary lengths thereof are different from each other. Thus, it is obvious from the measurement results shown in FIG. 5 that the risks of worsening the electromagnetic noise characteristics differ if the boundary lengths differ even though the areas are the same.

Thus, it is found from the measurement results shown in FIG. 5 that the closed curve length shown in FIG. 12 becomes an index for a level classification of a risk of worsening an electromagnetic noise characteristic. Moreover, this can be also described from a view of an induced voltage to a wiring by electromagnetic noise mixed from the outside of a printed wiring board. FIG. 13 is a top view of a plane conducting body with a slit and a wiring adjacent thereto, and schematically shows noise current flowing in the plane conductor body when electromagnetic noise is applied from the edge of the plane conductor body of the lower left of the drawing. The noise current flows on the plane conducting body, and an electromagnetic field generated thereby is combined with the wiring to cause an induced voltage. This noise current flows along the plane conducting body. However, since a conductor is lacked in the portion of the slit, the noise current flows through the periphery of the slit. In the neighborhood of such slit, a strong electromagnetic field is generated in particular by the noise current. And this electromagnetic field combines with a wiring adjacent to the slit and causes a higher induced voltage in the wiring. Thus, by the noise current which flows along the periphery of the slit, a strong electromagnetic field is generated. Therefore, it is considered that the length of the current path, that is, the boundary length of the slit becomes an index indicating a risk of worsening an electromagnetic noise characteristic. Although the slit formed inside the plane conducting body has been described in FIG. 13, an electromagnetic field is also generated similarly in a substrate end slit formed in an end of a plane conducting body and in an opening between a plurality of plane conducting bodies. And it is considered that the strength of the electromagnetic field depends on the length of the current path, that is, the closed curve length of the border line between a forming region and a non-forming region of a plane conducting body.

It is found from the above that the closed curve length shown in FIG. 12 can be used as an index for a level classification of a risk of worsening an electromagnetic noise characteristic.

As described above, by the wiring check system 200 of this exemplary embodiment, it is possible to appropriately extract a part, when a risk of worsening an electromagnetic noise characteristic is higher in particular, between different plane conductor bodies and a substrate end slit a wiring crosses, and to digitize the risk. Moreover, it is possible to also digitize and grasp the difference in the risks of worsening an electromagnetic noise characteristic due to the difference in the slit shapes. Therefore, a measure design can be preferentially performed from the part where a risk of worsening an electromagnetic noise characteristic is higher, and the deterioration of the electromagnetic noise characteristic can be prevented effectively and efficiently. As a result, the reliability of an electronic apparatus can be improved.

In FIG. 12, although the length of the closed curve length is shown, it is not limited to this. For example, it may be grouped by depending on the risk level in such a way that the risk is “low” when the closed curve length is less than 10 mm, the risk is “middle” when from 10 to 100 mm, and the risk is “high” when equal to 100 mm or more. And the output device 230 may output the result of the grouping. Thereby, it is possible to perform the grouping of the part which is high in the risk of worsening an electromagnetic noise characteristic and should be taken measures preferentially, and to use the detection result of the closed curve length more efficiently. In this exemplary embodiment, for example, the points D, F, G and J are grouped into the risk “high” and others into the risk “middle”. It is also possible to calculate the sum of the closed curve length for each wiring, and to perform ranking of the risk for each wiring. In this exemplary embodiment, if the closed curve length is totaled for every wiring, since the wiring 241 is not a crossing wiring, the total becomes zero. The total is 24 mm for the wiring 242, 230 mm for the wiring 243, 332 mm for the wiring 244, and 136 mm for the wiring 245. As a result, it is found that the wiring 244 is the wiring with the highest risk of worsening an electromagnetic noise characteristic.

In this exemplary embodiment, although the recording device 210 and the output device 230 are provided independently from the wiring check device 220, it is not limited to this. That is, a recording unit and an output unit may be provided inside the wiring check device 220 instead of the recording device 210 and the output device 230.

### Third Exemplary Embodiment

Next, a relation between an arrangement of a plane conducting body in a multilayer PWB and a risk of worsening an electromagnetic noise characteristic will be described before a description about a third exemplary embodiment of the present invention.

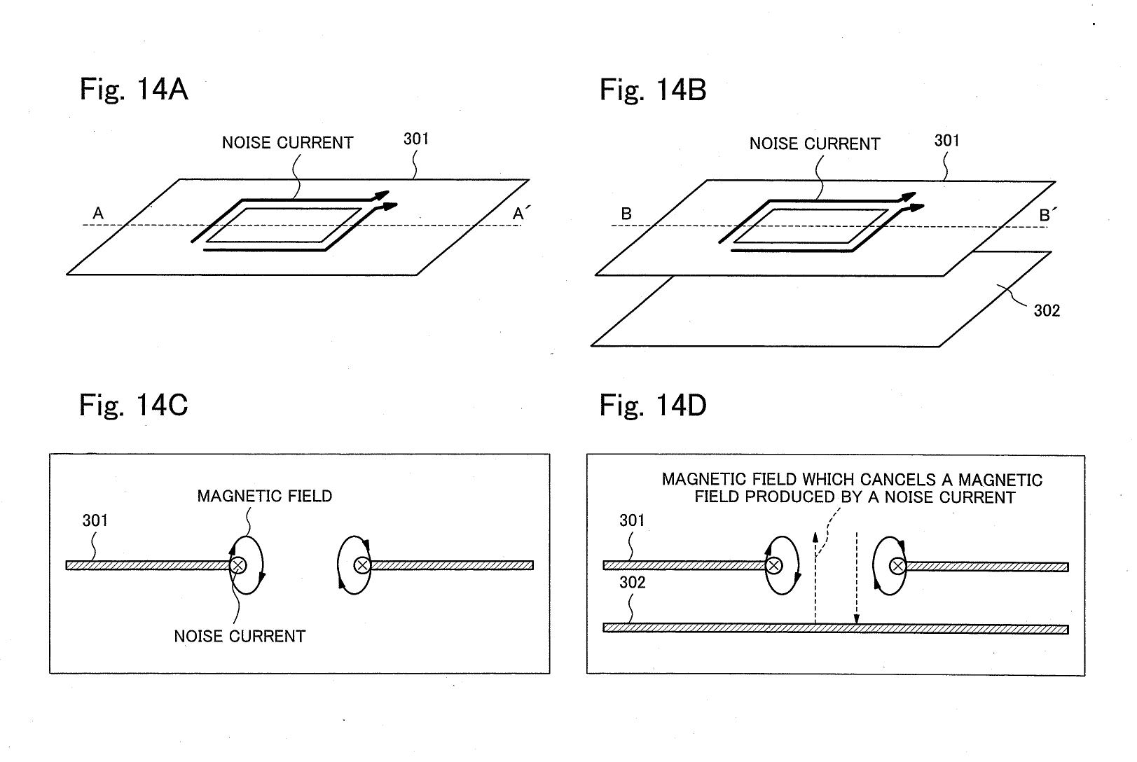

FIG. 14 shows a noise current which flows through the periphery of the slit formed in a plane conducting body, and a magnetic field which is generated occurs by a noise current. FIG. 14A shows a case where there are no other plane conducting bodies in layers above and below the plane conducting body 301 with a slit. In this case, an electromagnetic field which has been generated in the neighborhood of the slit by a noise current combined with the wiring and induces a voltage if a wiring is disposed in a position opposing a slit of the plane conducting body 301. FIG. 14B shows a case where there is the other plane conducting body 302 having no slits in a lower layer of the plane conducting body 301 with a slit. In this case, a magnetic field which has been generated by a noise current flowing through a periphery of the slit in the plane conducting body 301 generates an eddy current on the surface of the plane conducting body 302. As shown in FIG. 14D, this eddy current generates a magnetic field with the reverse direction to the magnetic field generated by the noise current in the plane conducting body 301. And by the magnetic field generated by this eddy current, the magnetic field by the noise current in the plane conducting body 301 is cancelled, and the electromagnetic field around the slit is weakened. As a result, even if the wiring is disposed in the position opposing the slit of the plane conducting body 301, a voltage induced in the wiring becomes smaller. That is, a risk of worsening an electromagnetic noise characteristic is reduced because other plane conducting body 302 exists in the position directly above or directly below the slit of the plane conducting body 301.

In FIG. 14B, the magnetic field generated by the noise current in the plane conducting body 301 is combined more strongly with the plane conducting body 302 as the distance between the plane conducting body 301 and the plane conducting body 302 is closer. Thereby the eddy current generated in the plane conducting body 302 also becomes larger, and the effect that cancels the magnetic field by the noise current in the plane conducting body 301 becomes higher. That is, a risk of worsening an electromagnetic noise characteristic is reduced as the distance between the plane conducting bodies is closer.

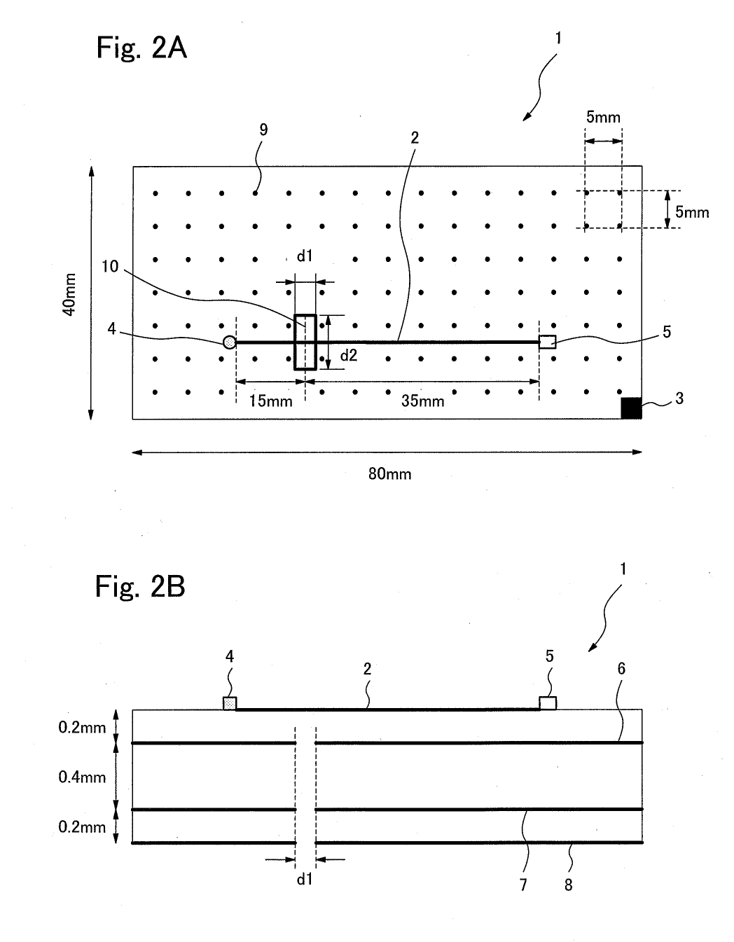

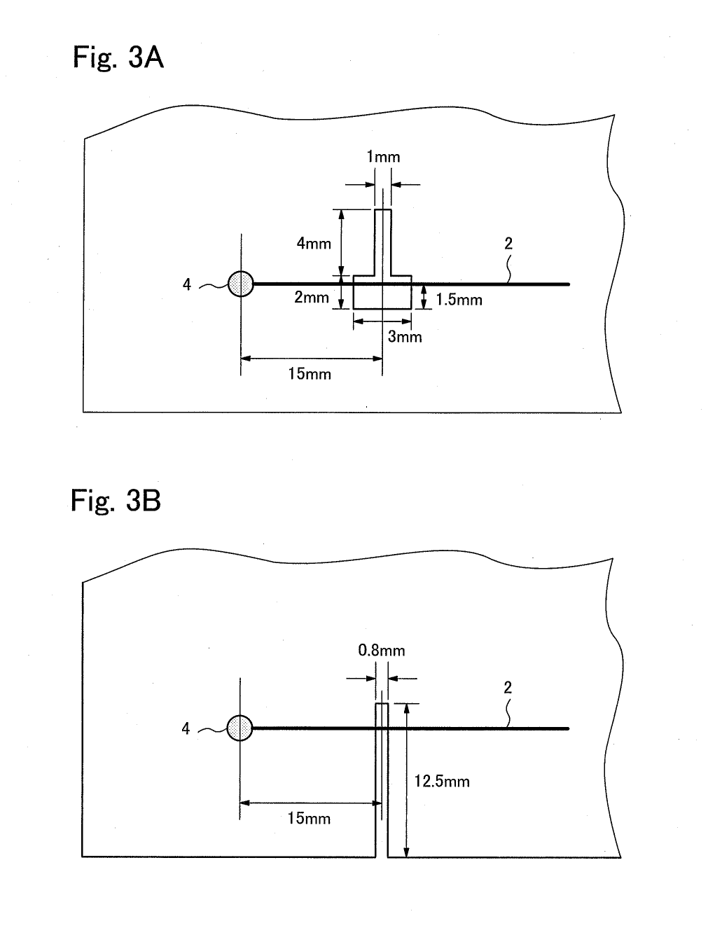

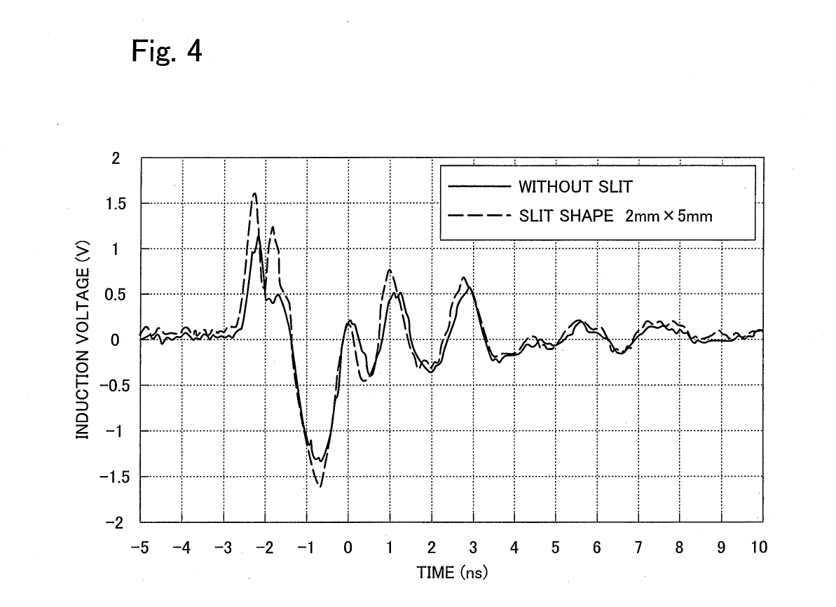

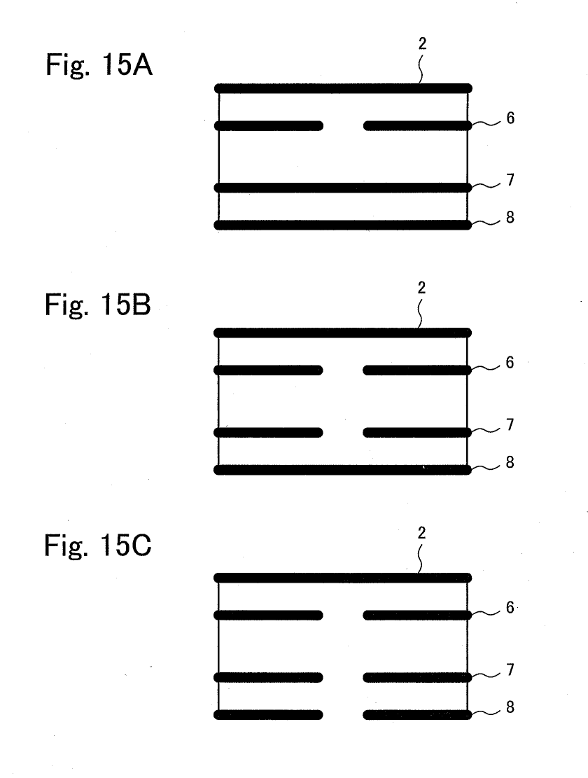

Next, results which have been evaluated more in detail about the effect of reducing a risk of worsening an electromagnetic noise characteristic will be described. A structure of a printed wiring board used for the evaluation is the same structure as a printed wiring board 1 shown in FIG. 2 except for a formation position of a slit. In this evaluation, printed wiring boards of three patterns are evaluated in order to perform measuring in a case of forming slits in plane conducting bodies 6 to 8 and a case of not forming them. FIG. 15 shows sectional views of the slit peripheries of the printed wiring boards of three patterns to be the evaluation targets. A shape of the slit shown in FIG. 15A is named a slit pattern 1. In the slit pattern 1, a slit is formed only in the plane conducting body 6, and a slit is not formed in the plane conducting body 7 and the plane conducting body 8. A shape of the slit shown in FIG. 15B is named a slit pattern 2. In the slit pattern 2, slits of equal size are formed in the plane conducting body 6 and the plane conducting body 7, respectively, and a slit is not formed in the plane conducting body 8. A shape of the slit shown in FIG. 15C is named a slit pattern 3. In the slit pattern 3, slits of equal size are formed in the plane conducting bodies 6-8, respectively. An induced voltage to the wiring 2 is measured when electromagnetic noise is applied from a pad 3 on the top layer for those slit patterns 1-3 under the same environment as the time of the measurement about the printed wiring board 1 shown in FIG. 2. And, as a standard, a printed wiring board is also evaluated in which a slit is not formed in any layers.

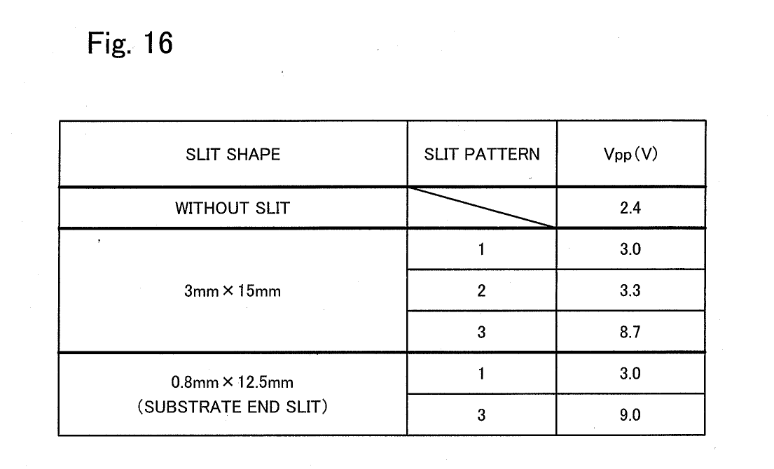

FIG. 16 shows the shapes of the slit, the slit patterns and the Peak-to-Peak values of the induced voltage. It is found from the diagram thereof that the induced voltage becomes the largest in the slit pattern 3 in which the slit is formed in all plane conducting bodies 6-8. On the other hand, it is found that the induced voltage is smaller in the slit pattern 1 and the slit pattern 2 in which there is a plane conducting body without having a slit, compared with the slit pattern 3. Moreover, the induced voltage in the slit pattern 1 is smaller than that in the slit pattern 2. Here, the distance between the plane conducting body 6 and the plane conducting body 7 not having slits in the slit pattern 1 is shorter than the distance between the plane conducting body 6 and the plane conducting body 8 not having slits in the slit pattern 2. It is found that a risk of worsening an electromagnetic noise characteristic is reduced as the distance between the plane conducting body in which a slit is formed and the plane conducting body not having slits formed in other layers is near.

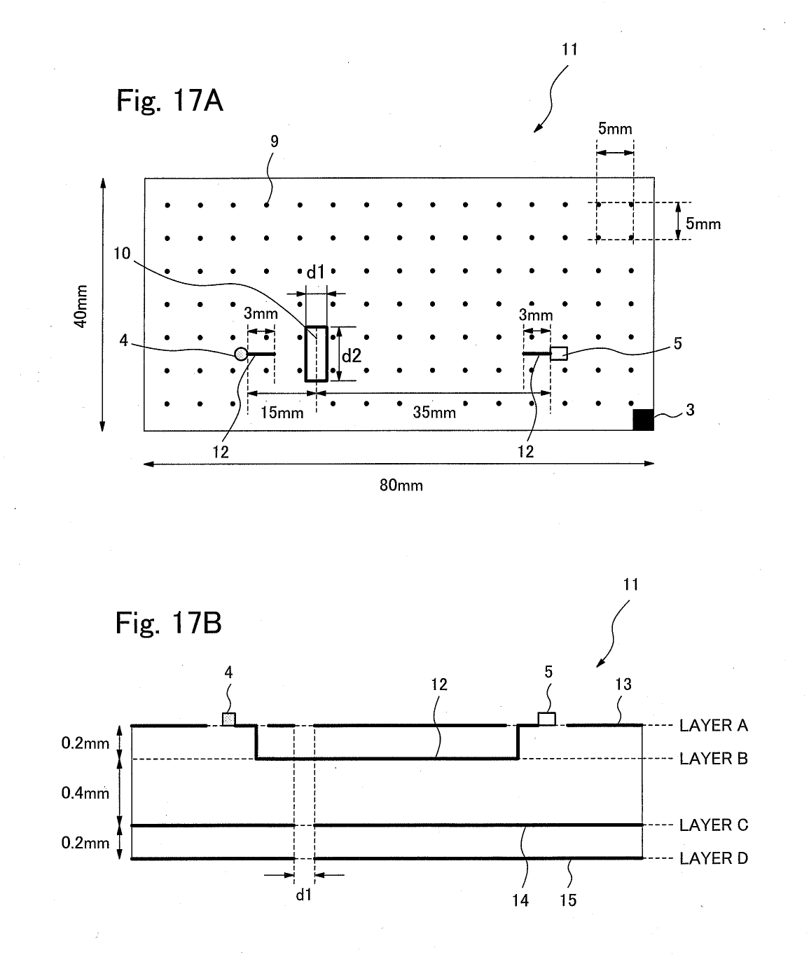

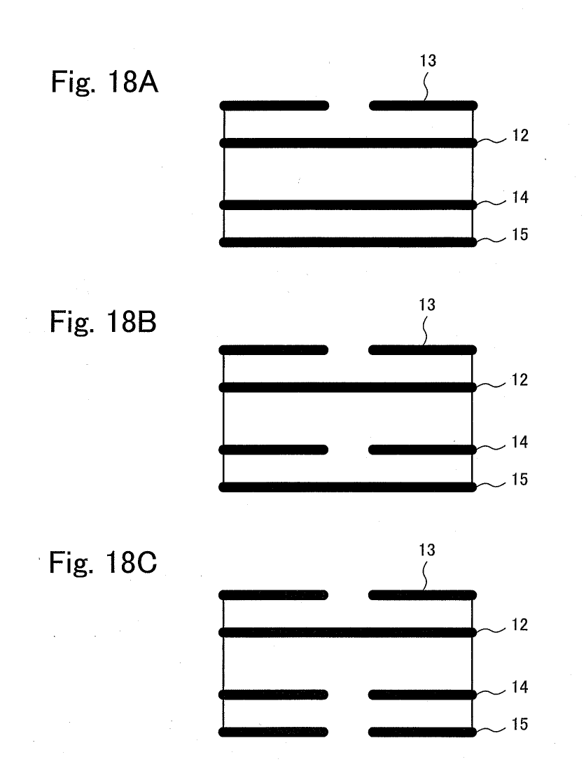

Next, results of performing similar evaluation will be described about a case where there is a plane conducting body in an above layer and a below layer of a wiring, respectively. FIG. 17 shows a schematic diagram of a structure of a printed wiring board 11 used for the evaluation. The printed wiring board 11 includes 4 layer structure of layers A to D. Wirings 12 are formed in the layer A and the layer B, and are connected by a via 9. Plane conducting bodies 13-15 are formed in the layers A, C and D, respectively and these are connected each other by the vias 9 disposed at intervals of 5 mm. A pad 3 for applying electromagnetic noise is formed in the layer A. Slits are formed in a part in the plane conducting bodies 13-15, respectively opposed to the wiring 12 in the layer B. The shape of the slit and the position to be formed are similar to those of the slit formed in the printed wiring board 1 shown in FIG. 2. An induced voltage to the wiring 12 when applying electromagnetic noise from the pad 3 on the layer A is measured using such the printed wiring board. Here, printed wiring boards with three patterns are evaluated in order to perform measuring about a case for forming slits in plane conducting bodies in the layers A, C and D and a case for not forming them. FIG. 18 shows sectional views of the slit peripheries of the printed wiring boards with three patterns which are the evaluation targets. A shape of a slit shown in FIG. 18A is named a slit pattern 4. In the slit pattern 4, a slit is formed only in a plane conducting body 13, and a slit is not formed in plane conducting bodies 14 and 15. A shape of a slit shown in FIG. 18B is named a slit pattern 5. In the slit pattern 5, slits are formed in plane conducting bodies 13 and 14, and a slit is not formed in a plane conducting body 15. A shape of the slit shown in FIG. 18C is named a slit pattern 6. In the slit pattern 6, slits are formed in all plane conducting bodies 13-15. And, as a standard, it is also evaluated about a printed wiring board in which a slit is not formed in any layers.

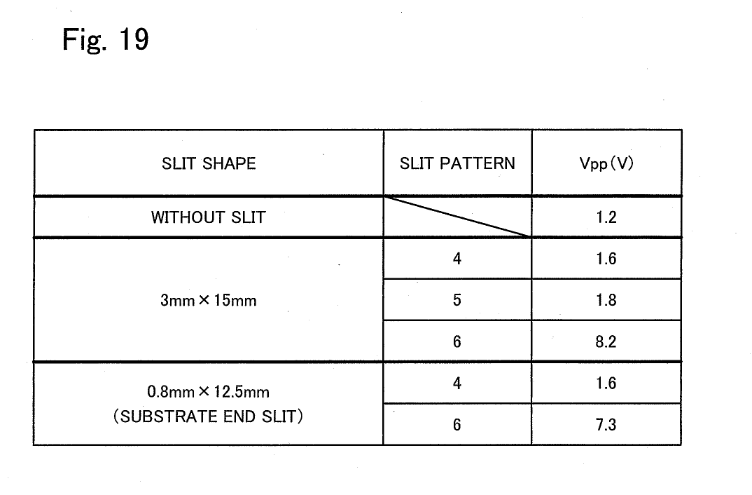

FIG. 19 shows the shapes of the slit, the slit patterns and the Peak-to-Peak values of the induced voltage. As a result, it is found that the induced voltage in the slit pattern 6 is the largest. And it is found that the induced voltage in the slit pattern 5 is longer than that in the slit pattern 4.

In a general multilayer PWB, there are a plurality of plane conducting bodies in the substrate laminating direction. Therefore, there are a lot of configurations which include a plane conducting body reducing the influence of a slit similarly to the measurement results mentioned above. For this reason, in a wiring check system, a more highly precise level separation becomes possible by appropriately correcting the level of the risk of worsening an electromagnetic noise characteristic based on the positional relationship between the slit and the plane conducting body.

Accordingly, in this exemplary embodiment, a wiring check system is described in consideration of the positional relationship of not only the plane conducting body in which a slit is formed but also the other plane conducting bodies.

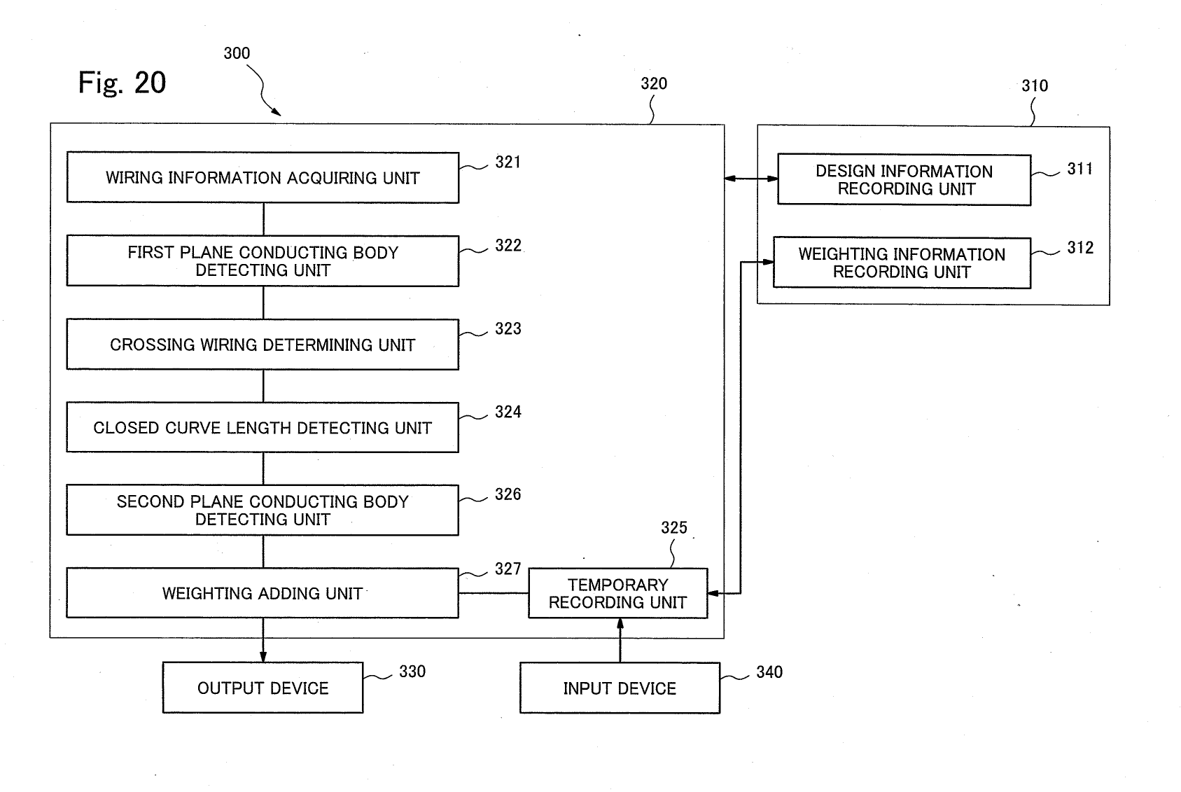

A wiring check system in the third exemplary embodiment of the present invention will be described using FIG. 20. A wiring check system 300 in this exemplary embodiment includes a recording device 310, a wiring check device 320, an output device 330 and an input device 340.

The recording device 310 includes a setting information recording unit 311 and a weighting information recording unit 312. The setting information recording unit 311 records design information on a printed wiring board, for example, a CAD data. For example, location information on a wiring in a printed wiring board is included in the design information. The weighting information recording unit 312 records weighting setting information. The weighting setting information means setting information on weighting for a closed curve length detected by a closed curve length detecting unit 324. The weighting setting information is sent and received via a temporary recording unit 325 to and from the input device 340.

The wiring check device 320 includes a wiring information acquiring unit 321, a first plane conducting body detecting unit 322, a crossing wiring determining unit 323, a closed curve length detecting unit 324, a temporary recording unit 325, a second plane conducting body detecting unit 326 and a weighting adding unit 327.

The wiring information acquiring unit 321 refers to the design information recorded in the design information recording unit 311 and acquires wiring information on a wiring to be a check target. The first plane conducting body detecting unit 322 detects the first plane conducting body adjacent to the wiring. The crossing wiring determining unit 323 detects overlapped projections of the wiring and the first plane conducting body detected by the first plane conducting body detecting unit 322. And it determines whether the wiring is a crossing wiring which crosses a border line between a forming region of the first plane conducting body and a non-forming region of the first plane conducting body. Here, if the wiring to be a check target is determined to be a crossing wiring, the closed curve length detecting unit 324 detects a closed curve length of the border line. The temporary recording unit 325 temporarily records the weighting setting information received from the input device 340. The temporary recording unit 325 performs sending and receiving, for example, storing and discharging, weighting information to and from the weighting information recording unit 312 in the recording device 310. The second plane conducting body detecting unit 326 detects the second plane conducting body formed in a position directly above or directly below the part of the border line between a forming region and a non-forming region of the first plane conducting body where the crossing wiring crosses. The weighting adding unit 327 adds a weighting coefficient to the closed curve length detected by the closed curve length detecting unit 324 based on the detection results by the second plane conducting body detecting unit 326 and the weighting setting information recorded in the temporary recording unit 325.

The output device 330 outputs information on the closed curve length detected by the closed curve length detecting unit 324 or information thereof to which the weighting coefficient was added.

The input device 340 inputs the weighting setting information.

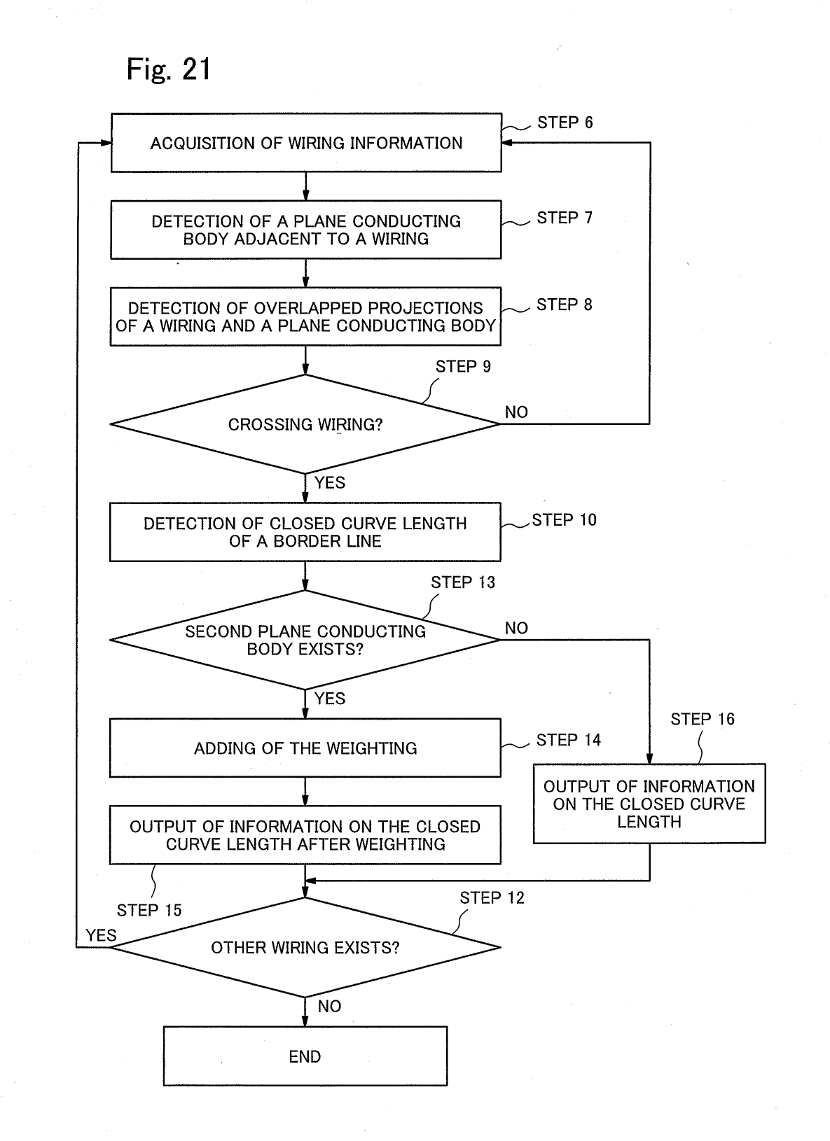

Next, a method for a wiring check by the wiring check system 300 of this exemplary embodiment will be described using FIG. 21. The description about Steps 6-10 is omitted because these are the same as those in the second exemplary embodiment.

In this exemplary embodiment, after Step 10, the second plane conducting body detecting unit 326 detects the second plane conducting body which is formed in a position directly above or directly below a part at which a crossing wiring crosses a border line between a forming region and a non-forming region in the first plane conducting body (Step 13).

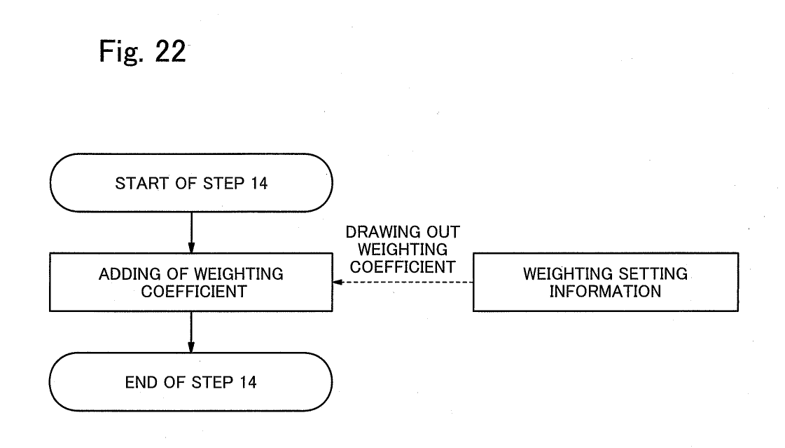

Here, if the second plane conducting body is detected, the weighting adding unit 327 adds a weighting coefficient to the closed curve length detected in Step 10 based on the detection results by Step 13 and the weighting setting information recorded in the temporary recording unit 325 (Step 14). The case where this second plane conducting body is detected means a case determined to select YES in Step 13. The weighting setting information inputted from the input device 340 is recorded in the temporary recording unit 325. If the weighting setting information extracted from the weighting information recording unit 312 has already been recorded in the temporary recording unit 325, the recorded weighting setting information is updated based on the weighting setting information inputted from the input device 340. The value of the weighting coefficient is extracted from the weighting setting information and is added to the closed curve length as shown in FIG. 22.

And the output device 330 outputs information on the closed curve length, after the weighting coefficient is added by Step 14 (Step 15). On the other hand, if the second plane conducting body detecting unit 326 does not detect the second plane conducting body, that is, if determined to select NO in Step 13, the output device 330 outputs information on the closed curve length detected by the closed curve length detecting unit 324 (Step 16). For example, information to be output is output for each wiring.

The wiring check by the wiring check system 300 of this exemplary embodiment is performed in a way mentioned above.

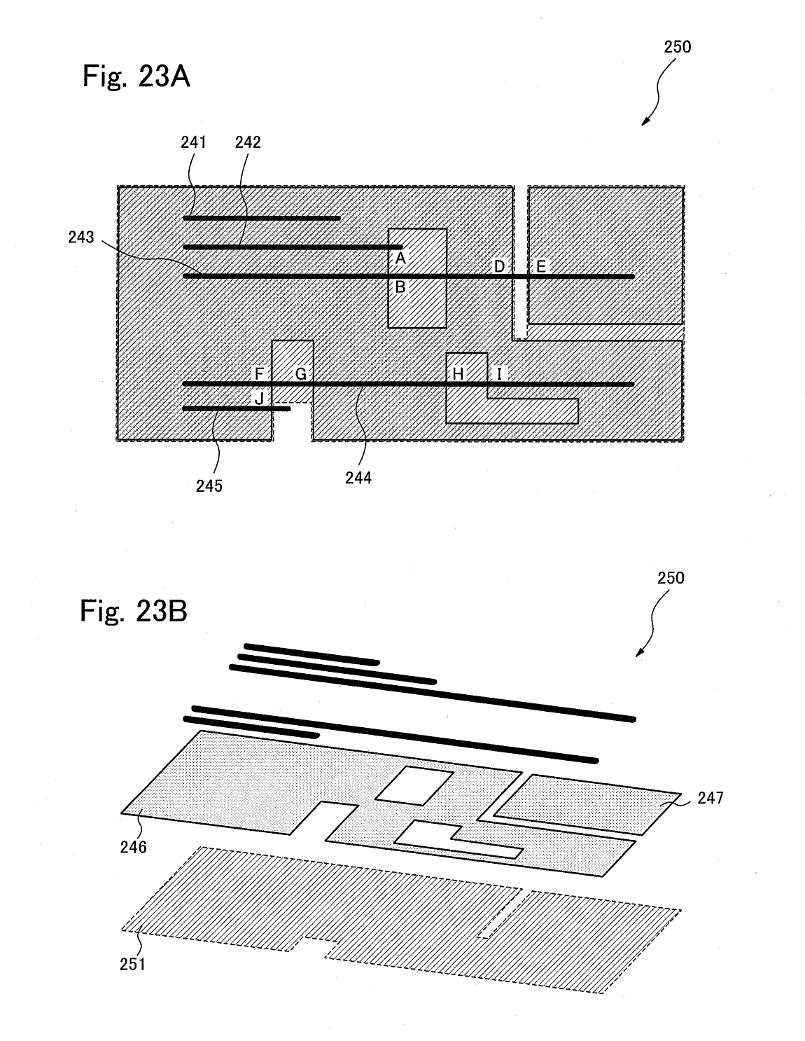

Next, a wiring check by the wiring check system 300 in this exemplary embodiment will be described using an example in detail. Here, a case where a wiring check of the printed wiring board 250 shown in FIG. 23 is performed will be described.

A printed wiring board 250 shown in FIG. 23 includes a structure in which a plane conducting body 251 is added in a lower layer of the wirings 241-245 and the plane conducting bodies 246 and 247 shown in FIG. 11. FIG. 23A shows a top view of a printed wiring board 250, and FIG. 23B shows a perspective view thereof. Although the detailed size of the plane conducting body 251 is not written, the planar shape corresponds to the slant line part surrounded with a dotted line of FIG. 23A. As can be seen from FIG. 23A, there is a plane conducting body 251 in positions directly below the points A, B, C, F, G, H and I. Therefore, as the second plane conducting body that reduces a risk of worsening an electromagnetic noise characteristic, the plane conducting body 251 is detected. On the other hand, the plane conducting body 251 is lacked in a position directly below the points D, E and J, and it is not formed. Therefore, the second plane conducting body is not detected.

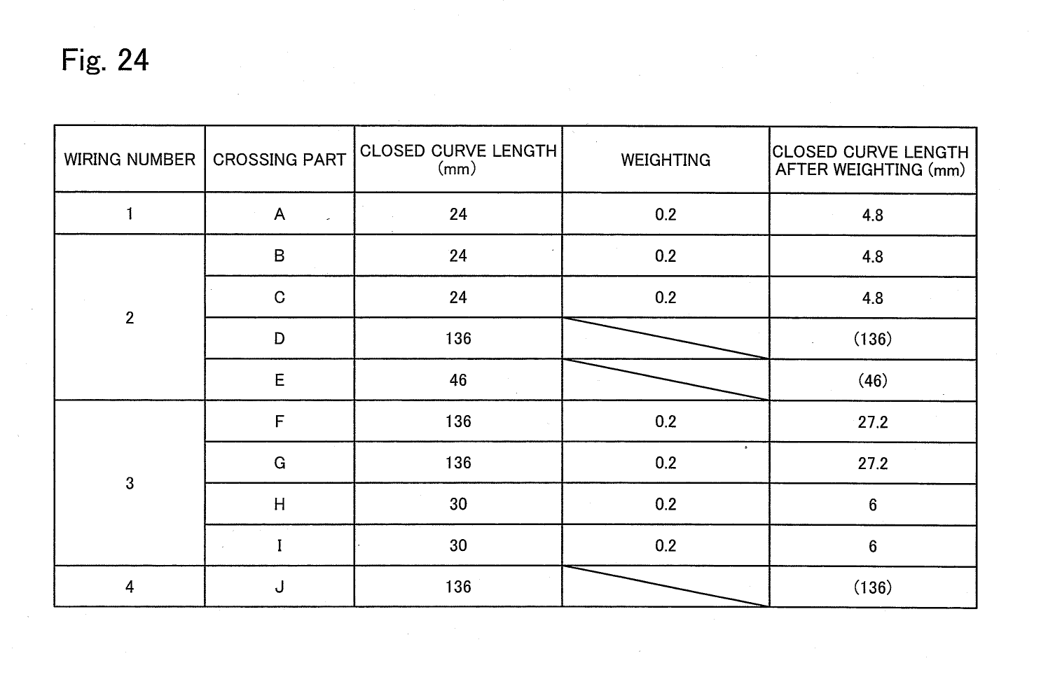

The results obtained by performing a wiring check of the printed wiring board 250 with the wiring check system 300 are shown in FIG. 24. The weighting coefficient is set to 0.2. That is, if the second plane conducting body is detected by the second plane conducting body detecting unit 326, the closed curve length detected by the closed curve length detecting unit 324 detected is multiplied by the weighting coefficient 0.2. The value of the weighting coefficient can be changed appropriately via the input device 340, for example.

As shown in FIG. 24, at a part where a risk of worsening an electromagnetic noise characteristic is reduced by a plane conducting body 251, the weighting coefficient is added (Step 14). And at a part where a risk of worsening an electromagnetic noise characteristic is not reduced, the weighting coefficient is not added. Therefore, the level of the risk of worsening an electromagnetic noise characteristic can be judged from the information output by Steps 15 and 16 in consideration of the effect of the reduction in risk of worsening an electromagnetic noise characteristic by the second plane conducting body. It is found from FIG. 24 that the risk of worsening an electromagnetic noise is the highest at the point D of the wiring 243 and the point J of the wiring 245, and next highest at the point E of the wiring 243.

As described above, in the wiring check system of this exemplary embodiment, the second plane conducting body is detected which is formed in the position directly above or directly below the part of the border line between the forming region and the non-forming region of the plane conducting body which the crossing wiring crosses. And the effect of the reduction in the risk of worsening the electromagnetic noise characteristic by the second plane conducting body is reflected as the weighting coefficient of the risk. Thereby, it is possible to understand more exactly the risk of worsening an electromagnetic noise characteristic, and to perform a measure design of a high risk part preferentially. Therefore, it is possible to prevent the worsening of the electromagnetic noise characteristic can be prevented effectively and efficiently.

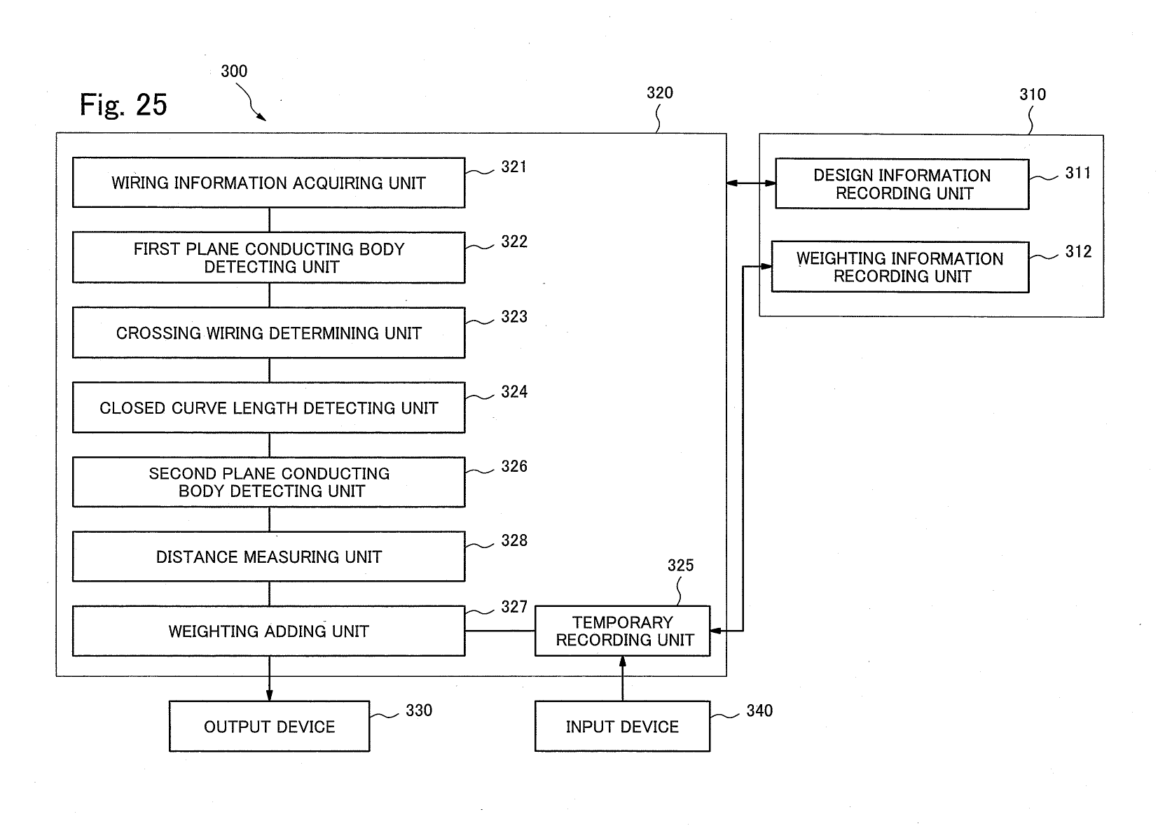

A value of the weighting coefficient may be changed depending on an arrangement of the second plane conducting body. It is indicated from the measurement results shown in FIG. 16 mentioned above that Vpp becomes lower as the distance between the two planes is nearer, that is, the risk of worsening an electromagnetic noise characteristic is further reduced. Accordingly, as shown in FIG. 25, the wiring check system 300 may further include a distance measuring units 328. The distance measuring unit 328 measures the distance between the first plane conducting body and the second plane conducting body in the laminating direction of a plane conducting body. And depending on the distance measured by the distance measuring unit 328, the weighting coefficient added in Step 14 may be changed. For example, if the distance between the two plane conducting bodies is 0.1 mm, the weighting may be set at 0.1, and if the distance is 0.3 mm, the weighting may be set at 0.3. As a result, the distance between the plane conducting body is reflected in the value that indicates a risk of worsening an electromagnetic noise characteristic, and it is possible to understand more exactly the level of the risk. Therefore, it is possible to prevent the worsening of an electromagnetic noise characteristic can be prevented more effectively and efficiently.

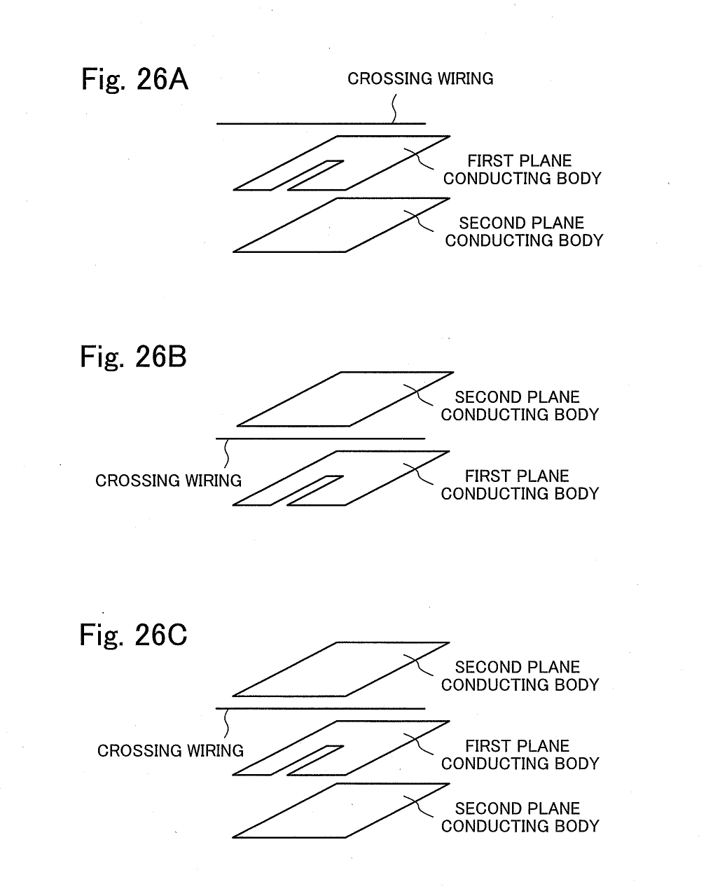

Next, a case is considered where there exists the second plane conducting body exists in an upper layer and a lower layer, respectively of the first plane conducting body. As an example, a case where a wiring check of a printed wiring board shown in FIG. 26 is performed is described. FIG. 26A shows a configuration in which the second plane conducting body is located in a lower layer of the first plane conducting body. FIG. 26B shows a configuration in which the second plane conducting body is located in an upper layer of a crossing wiring. FIG. 26C shows a configuration in which the second plane conducting body is located in an upper layer of a crossing wiring and a lower layer of the first plane conducting body, respectively. The weighting coefficient can be added to the closed curve length by the same method as that in case of the wiring check of the printed wiring board shown in FIG. 23 in performing a wiring check of the printed wiring board shown in FIG. 26A and FIG. 26B. On the other hand, in case of the printed wiring board shown in FIG. 26C, it is considered that a risk of worsening an electromagnetic noise characteristic is reduced greatly by two pieces of the second plane conducting body in the drawing than that in the configuration of the printed wiring board shown in FIG. 26A and FIG. 26B. In such case, the weighting coefficient may be multiplied twice to the closed curve length, for example with detecting two pieces of the second two plane conducting body.

Or, by considering the risk of worsening an electromagnetic noise characteristic very low, the weighting coefficient may be set at zero. Or, it is also possible not to output an extraction results of the closed curve length considering it not to be a crossing wiring. Thereby, it is possible to understand more exactly the risk of worsening an electromagnetic noise characteristic, and to prevent the worsening of an electromagnetic noise characteristic can be prevented more effectively and efficiently. In this exemplary embodiment, although the input device 340 is provided, but it is not limited to this. That is, the input device 340 is not provided and the weighting coefficient may be added using the setting information recorded in the weighting information recording unit 312 in advance.

It goes without saying that the first exemplary embodiment to the third exemplary embodiment can be realized by preparing a recording medium in which a program code of software which realizes the function of each exemplary embodiment is recorded, and by making a general-purpose computer read the program code stored in the recording medium and operate as a wiring check device.

As the recording medium which supplies the program, for example, it may be used which can memorize the above-mentioned program such as CD-ROM (Compact Disc Read Only Memory), DVD-R (Digital Versatile Disk Recordable), an optical disc, a magnetic disk and a non volatility memory card.

The wiring check system described in the first exemplary embodiment to the third exemplary embodiment is applicable to the use such as the wiring check tools of a printed wiring board for improving an electromagnetic noise characteristic.

The whole or part of the exemplary embodiment described above can be described as, but not limited to, the following supplementary notes.

(Supplementary note 1) A wiring check device characterized in including: a wiring information acquiring unit for acquiring the wiring information of wiring; a first plane conducting body detecting unit for detecting a first plane conducting body adjacent to the wiring; a crossing wiring determining unit for detecting overlapped projections of the wiring and the first plane conducting body, and determining whether or not the wiring is a crossing wiring crossing a border line between a forming region of the first plane conducting body and a non-forming region of the first plane conducting body; and a closed curve length detecting unit for detecting closed curve length of the border line if it is determined that the wiring is a crossing wiring.
(Supplementary note 2) The wiring check device described in supplementary note 1, characterized in further including an output unit for grouping the wiring based on a detection result by the closed curve detecting unit and outputting the result of the grouping.
(Supplementary note 3) The wiring check device described in supplementary notes 1 or 2, characterized in further including a second plane conducting body detecting unit for detecting a second plane conducting body formed in a position directly below or directly above a part at which the crossing wiring crosses the border line, among plane conducting bodies adjacent to above and below the first plane conducting body.
(Supplementary note 4) The wiring check device described in supplementary note 3, characterized in further including a distance measuring unit for measuring a distance between the first plane conducting body and the second plane conducting body in the plane conducting body laminating direction.
(Supplementary note 5) The wiring check device described in supplementary note 3 or 4, characterized in further including a weighting adding unit for adding a weighting coefficient to the closed curve length extracted by the closed curve length extraction unit based on the detection result by the second plane conducting body detecting unit.
(Supplementary note 6) The wiring check device described in supplementary note 4, characterized in further including a weighting adding unit for adding a weighting coefficient to the closed curve length extracted by the closed curve length extraction unit based on the detection result by the second plane conducting body detecting unit and the measurement result by the distance measuring unit.
(Supplementary note 7) A wiring check system characterized in including: a wiring information acquiring means for acquiring wiring information of wiring; a first plane conducting body detecting means for detecting a first plane conducting body adjacent to the wiring; a crossing wiring determining means for detecting overlapped projections of the wiring and the first plane conducting body, and determining whether or not the wiring is a crossing wiring crossing a border line between a forming region of the first plane conducting body and a non-forming region of the first plane conducting body; and a closed curve length detecting means for detecting the closed curve length of the border line if it is determined that the wiring is a crossing wiring.
(Supplementary note 8) The wiring check system described in Supplementary note 7, characterized in further including an output means for grouping the wiring based on the detection result the closed curve detecting means and outputting a result of the grouping.
(Supplementary note 9) The wiring check system described in supplementary notes 7 or 8, characterized in further including a second plane conducting body detecting means for detecting a second plane conducting body formed in a position directly below or directly above a part at which the crossing wiring crosses the border line, among plane conducting bodies adjacent to above and below the first plane conducting body.
(Supplementary note 10) The wiring check system described in supplementary note 9, characterized in further including a distance measurement means for measuring a distance in the plane conducting body laminating direction of the first plane conducting body and the second plane conducting body.
(Supplementary note 11) The wiring check system described in supplementary notes 9 or 10, characterized in further including a weighting adding means for adding a weighting coefficient to the closed curve length extracted by the closed curve length extraction means based on the detection result by the second plane conducting body detecting means.
(Supplementary note 12) The wiring check system described in supplementary note 10, characterized in further including a weighting adding means for adding a weighting coefficient to the closed curve length extracted by the closed curve length extraction means based on the detection result by the second plane conducting body detecting means and the measurement result by the distance measurement means.
(Supplementary note 13) A wiring check method characterized in including: a wiring information acquiring step for acquiring the wiring information of wiring; a first plane conducting body detecting step for detecting a first plane conducting body adjacent to the wiring; a crossing wiring determining step for detecting overlapped projections of the wiring and the first plane conducting body, and determining whether or not the wiring is a crossing wiring crossing a border line between a forming region of the first plane conducting body and a non-forming region of the first plane conducting body; and a closed curve length detecting step for detecting the closed curve length of the border line if it is determined that the wiring is a crossing wiring.
(Supplementary note 14) The wiring checking method described in supplementary note 7 characterized in further including an output step for grouping the wiring based on the detection result by the closed curve detection step and outputting a result of the grouping.
(Supplementary note 15) The wiring checking method described in supplementary notes 13 or 14 characterized in further including a second plane conducting body detecting step for detecting a second plane conducting body formed in a position directly below or directly above a part at which the crossing wiring crosses the border line, among plane conducting bodies adjacent to above and below the first plane conducting body.
(Supplementary note 16) The wiring checking method described in supplementary note 15 characterized in further including a distance measuring step for measuring a distance in the plane conducting body laminating direction of the first plane conducting body and the second plane conducting body.
(Supplementary note 17) The wiring checking method described in supplementary notes 15 or 16 characterized in further including a weighting adding step for adding a weighting coefficient to the closed curve length extracted by the closed curve length extraction step based on the detection result by the second plane conducting body detecting step.
(Supplementary note 18) The wiring checking method described in supplementary note 16 characterized in further including a weighting adding step for adding a weighting coefficient to the closed curve length extracted by the closed curve length extraction step based on the detection result by the second plane conducting body detecting step and the measurement result by the distance measurement step.
(Supplementary note 19) A wiring check program characterized in making a computer execute a wiring checking method described in any one of supplementary notes 13 to 18.
(Supplementary note 20) An information storage medium readable by a computer, wherein a wiring check program described in supplementary note 19 is recorded therein.

This application is based upon and claims the benefit of priority from Japanese Patent Application No. 2010-268547, filed on Dec. 1, 2010, the disclosure of which is incorporated herein in its entirety by reference.

### DESCRIPTION OF THE CODES

1, 11, 240, 250 printed wiring board
2, 12, 111, 241, 242, 243, 244, 245 wiring
3 pad
4 coaxial connector
5 resistor
6, 7, 8, 13, 14, 15, 246, 247, 251, 301, 302 plane conducting body
9 via
10, 248, 249, 250 slit
100, 200, 300 wiring check system
101 wiring information acquisition means
102 first plane conducting body detecting means
103 crossing wiring determining means
104 closed curve length detecting means
112 first plane conducting body
113 border line
210, 310 recording device
211, 311 design information recording unit
220, 320 wiring check device
221, 321 wring information acquiring unit
222, 322 first plane conducting body detecting unit
223, 323 crossing wiring determining unit
224, 324 closed curve length detecting unit
230, 330 output device
340 input device.
312 weighting information recording unit
325 temporary recording unit
326 second plane conducting body detecting unit
327 weighting adding unit
328 distance measuring unit

1. A wiring check device, comprising:
a wiring information acquiring unit for acquiring the wiring information of wiring;
a first plane conducting body detecting unit for detecting a first plane conducting body adjacent to the wiring;
a crossing wiring determining unit for detecting overlapped projections of the wiring and the first plane conducting body, and determining whether or not the wiring is a crossing wiring crossing a border line between a forming region of the first plane conducting body and a non-forming region of the first plane conducting body; and
a closed curve length detecting unit for detecting closed curve length of the border line if it is determined the wiring is a crossing wiring.

2. The wiring check device according to claim 1, further comprising an output unit for grouping the wiring based on a detection result by the closed curve detecting unit and outputting the result of the grouping.

3. The wiring check device according to claim 1, further comprising a second plane conducting body detecting unit for detecting a second plane conducting body formed in a position directly below or directly above a part at which the crossing wiring crosses the border line, among plane conducting bodies adjacent to above and below the first plane conducting body.

4. The wiring check device according to claim 3, further comprising a distance measuring unit for measuring a distance between the first plane conducting body and the second plane conducting body in the plane conducting body laminating direction.

5. The wiring check device according to claim 3, further comprising a weighting adding unit for adding a weighting coefficient to the closed curve length extracted by the closed curve length extraction unit based on the detection result by the second plane conducting body detecting unit.

6. The wiring check device according to claim 4, further comprising a weighting adding unit for adding a weighting coefficient to the closed curve length extracted by the closed curve length extraction unit based on the detection result by the second plane conducting body detecting unit and the measurement result by the distance measuring unit.

7. A wiring check system comprising:
a wiring information acquiring means for acquiring wiring information of wiring;
a first plane conducting body detecting means for detecting a first plane conducting body adjacent to the wiring;
a crossing wiring determining means for detecting overlapped projections of the wiring and the first plane conducting body, and determining whether or not the wiring is a crossing wiring crossing a border line between a forming region of the first plane conducting body and a non-forming region of the first plane conducting body; and
a closed curve length detecting means for detecting the closed curve length of the border line if it is determined that the wiring is a crossing wiring.

8-10. (canceled)

11. The wiring check system according to claim 7, further comprising an output means for grouping the wiring based on the detection result the closed curve detecting means and outputting a result of the grouping.

12. The wiring check system according to claim 7, further comprising a second plane conducting body detecting means for detecting a second plane conducting body formed in a position directly below or directly above a part at which the crossing wiring crosses the border line, among plane conducting bodies adjacent to above and below the first plane conducting body.

13. The wiring check system according to claim 12, further comprising a distance measurement means for measuring a distance in the plane conducting body laminating direction of the first plane conducting body and the second plane conducting body.

14. The wiring check system according to claim 12, further comprising a weighting adding means for adding a weighting coefficient to the closed curve length extracted by the closed curve length extraction means based on the detection result by the second plane conducting body detecting means.

15. The wiring check system according to claim 13, further comprising a weighting adding means for adding a weighting coefficient to the closed curve length extracted by the closed curve length extraction means based on the detection result by the second plane conducting body detecting means and the measurement result by the distance measurement means.

16. A wiring check method, comprising the steps of:
a wiring information acquiring step for acquiring the wiring information of wiring;
a first plane conducting body detecting step for detecting a first plane conducting body adjacent to the wiring;
a crossing wiring determining step for detecting overlapped projections of the wiring and the first plane conducting body, and determining whether or not the wiring is a crossing wiring crossing a border line between a forming region of the first plane conducting body and a non-forming region of the first plane conducting body; and
a closed curve length detecting step for detecting the closed curve length of the border line if it is determined that the wiring is a crossing wiring.

17. The wiring checking method according to claim 16, further comprising an output step for grouping the wiring based on the detection result by the closed curve detection step and outputting a result of the grouping.

18. The wiring checking method according to claim 16, further comprising a second plane conducting body detecting step for detecting a second plane conducting body formed in a position directly below or directly above a part at which the crossing wiring crosses the border line, among plane conducting bodies adjacent to above and below the first plane conducting body.

19. The wiring checking method according to claim 18, further comprising a distance measuring step for measuring a distance in the plane conducting body laminating direction of the first plane conducting body and the second plane conducting body.

20. The wiring checking method according to claim 18, further comprising a weighting adding step for adding a weighting coefficient to the closed curve length extracted by the closed curve length extraction step based on the detection result by the second plane conducting body detecting step.

21. The wiring checking method according to claim 19, further comprising a weighting adding step for adding a weighting coefficient to the closed curve length extracted by the closed curve length extraction step based on the detection result by the second plane conducting body detecting step and the measurement result by the distance measurement step.

22. A wiring check program making a computer execute a wiring checking method according to claim 16.

23. An information storage medium readable by a computer, wherein a wiring check program according to claim 22 is recorded therein.
